(19) United States
(12) Patent Application Publication
(10) Pub. No.: US 2026/0002077 A1
(43) Pub. Date: Jan. 1, 2026

(54) LIQUID CRYSTAL COMPOSITION AND LIQUID DISPLAY DEVICE

(71) Applicant: Jiangsu Hecheng Display Technology Co., Ltd., Nanjing (CN)

(72) Inventors: Dike PAN, Nanjing (CN); Wenquan DING, Nanjing (CN); Di HE, Nanjing (CN); Lifang YAO, Nanjing (CN); Fei ZHAO, Nanjing (CN); Panpan WANG, Nanjing (CN); Huijuan DAI, Nanjing (CN)

(73) Assignee: Jiangsu Hecheng Display Technology Co., Ltd., Nanjing (CN)

(21) Appl. No.: 19/136,103

(22) PCT Filed: Nov. 7, 2023
(86) PCT No.: PCT/CN2023/130201

§ 371 Date: Jun. 5, 2025

(30) Foreign Application Priority Data
Dec. 9, 2022 (CN) 202211588808.7

(51) Int. Cl. C09K 19/34

(52) U.S. Cl. CPC C09K 19/3491; C09K 19/3405; C09K 19/3494; C09K 2019/3408

(57) ABSTRACT

The present invention provides a liquid crystal composition and a liquid crystal display device. The liquid crystal composition comprises at least one compound of general formula I, at least one compound of general formula II and at least one compound of general formula III. The liquid crystal composition provided in the present invention has an appropriate optical anisotropy, an appropriate clearing point, an appropriate absolute value of dielectric anisotropy, a larger K value, a smaller rotational viscosity, a shorter response time, a higher transmittance, a higher contrast rate and a longer low-temperature storage time, and a liquid crystal display device prepared thereby has excellent performances and is suitable for fast-response, high-contrast VA, IPS, NFFS display modes and the like.

### TECHNICAL FIELD

The present invention belongs to the technical field of liquid crystal materials, specifically relates to a liquid crystal display device, and further specifically relates to a liquid crystal composition comprising an olefinic benzothiopheneyl based compound, as well as a liquid crystal display device.

### BACKGROUND ARTS

For its small size, light weight, low power consumption and excellent display quality, liquid crystal display (LCD) has achieved a rapid development, and especially a wide application in portable electronic information products. With the increase in the size of the liquid crystal screens for portable computers, office applications, video applications, the liquid crystal display can be used for large-screen displays and eventually replace the cathode ray tube (CRT) display.

Compared with traditional display devices and display materials, liquid crystal display materials have obvious advantages: low driving voltage, small power consumption, high reliability, large amount of display information, color display, no flicker, no harm to the human body, automatic production process, low cost, ability of being made into liquid crystal displays of various specifications and types, easy to be carried and so on. Because of these advantages, liquid crystal display technology has had a profound impact on the field of imaging display, and promoted the development of microelectronics technology and optoelectronic information technology. Liquid crystal materials have been widely used in many display occasions due to the good optical properties and photoelectric effects thereof. Therefore, the research on liquid crystal materials is getting deeper and deeper.

With the wide application of TFT-type LCDs, the requirements on the performance thereof constantly increase. High image display quality requires those having a faster response speed, a lower energy consumption, and higher low-temperature reliability, in addition to higher contrast rate and transmittance, especially for the IPS-type liquid crystal display mode. This means that liquid crystal materials need to have higher contrast rate and transmittance, higher elasticity constants, higher dielectric constants and low-temperature reliability, and the increase of these properties needs improvements of liquid crystal materials.

According to the equation of the transmittance for IPS mode T^{∝}|Δε|/ε_{⊥} (T represents transmittance, “∝” represents the “inverse proportion” relationship, and ε_{⊥} represents the dielectric constant perpendicular to the direction of the molecular axis). If an improvement of the transmittance of the liquid crystal is wanted, it might attempte to decrease the Δε of liquid crystal medium. But in general, the adjustment range for the drive voltage of the same product is limited. In addition, the liquid crystal molecules will tilt towards the Z axis under the action of the vertical component of the edge electric field. resulting in the change of its optical anisotropy./>

According to the equation

$$T = {sin}^{2} ( 2 χ ) {sin}^{2} ( \frac{π Δ nd}{λ} )$$

(wherein, χ is the angle between the optical axis of the liquid crystal layer and the optical axis of the polarizer, Δn is the optical anisotropy, d is the cell gap, and λ is the wavelength), it can be seen that effective Δn*d will affect T. If an improvement of the transmittance of the positive liquid crystal is wanted, increasing Δn*d can be taken into consideration, but the retardation amount for each product is designed to be fixed.

In another aspect, based on the light leakage performance test of traditional IPS-LCD, the main causes of the light leakage issues of liquid crystal display device are as follows: LC scattering, rubbing uniformity, CF/TFT scattering, and polarize ability, wherein, LC scattering accounts for 63% of the factors affecting light leakage performance.

According to the following equation: LC Scattering

$$∝ \frac{d •Δ {n}^{2} {\cdot ( {n}_{e} + {n}_{o} )}^{2}}{{K}_{ave}} ,$$

wherein, d represents the cell gap of the liquid crystal cell, nₑ represents the refractive index of extraordinary light, nₒ represents the refractive index of ordinary light.

In order to increase the LC scattering of the liquid crystal materials, increasing average elastic constant Kₐᵥₑ (wherein, Kₐᵥₑ=(K₁₁+K₂₂+K₃₃)/3) is needed to improve the LC scattering. In the situation of increasing the Kave, the light leakage of the liquid crystal material can be decreased.

In addition. the relationship between the contrast rate (CR) and the luminance (L) is as follows:

$$CR = {L}_{255} / {L}_{0} \times 100 \% ,$$

wherein, L₂₅₅ is the on-state luminance, and L₀ is the off-state luminance. It can be seen that CR is significantly affected by the change of L₀. In the off state, Lo has nothing to do with the dielectric performance of the liquid crystal molecule, but is related to the LC Scattering of the liquid crystal material itself. The smaller the LC Scattering, the smaller the L₀, and the CR is thereby significantly increased.

In view of the above, common methods for improving the contrast rate and transmittance may be considered from the following two aspects: (1) keeping the dielectric anisotropy Δε of the liquid crystal composition unchanged, the transmittance may be effectively improved by increasing ε_{⊥}; (2) increasing the value of the average elastic constant Kₐᵥₑ of a liquid crystal composition, such that the liquid crystal molecules become more organized, and have less light leakage, thereby improving the transmittance. However, the ε_{⊥}/Δε ratio of the liquid crystal composition provided in the prior art is lower and Kₐᵥₑ is lower, causing an insufficient transmittance, a slow response and a poor low-temperature storage performance. Therefore, how to provide a liquid crystal composition that can solve the above problems is still an urgent technical problem to be solved in this field.

### SUMMARY OF THE INVENTION

Regarding the disadvantages in the prior art, it is an object of the present invention to provide a liquid crystal composition and a liquid crystal display device. Via designing the specific constitution of the liquid crystal composition, and further using the compound of general formula I containing cycloalkenyl groups in conjunction with the compound of general formula II and the compound of general formula III, the liquid crystal composition prepared in the present invention has an appropriate optical anisotropy, an appropriate clearing point. an appropriate absolute value of dielectric anisotropy, a larger K value, a smaller rotational viscosity, a shorter response time, a higher transmittance, a higher contrast rate and a longer low-temperature storage time, which makes the liquid crystal display device containing the liquid crystal composition of the present invention have a wider using temperature range, a lower threshold voltage, a better contrast rate, a faster response speed, a faster refresh speed and a higher transmittance, and suitable for fast-response, high-contrast VA, IPS, NFFS display modes and the like.

To realize this object, the present invention adopts the following technical solutions:

In a first aspect, the present application provides a liquid crystal composition comprising at least one compound of general formula 1, at least one compound of general formula II and at least one compound of general formula III:

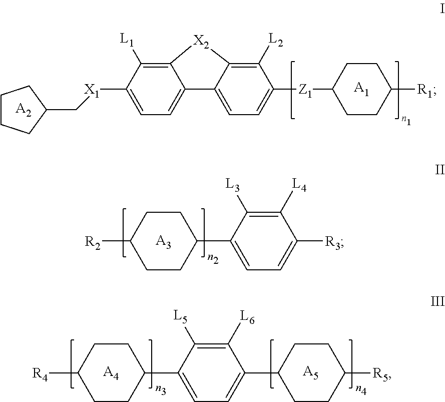

wherein, R₁ represents —H, C₁₋₁₂ (for example, it can be C₁, C₂, C₃, C₄, C₅, C₆, C₇, C₈, C₉, C₁₀, C₁₁ or C₁₂) halogenated or unhalogenated linear alkyl, C₃₋₁₂ (for example, it can be C₃, C₄, C₅, C₆, C₇, C₈, C₉, C₁₀, C₁₁ or C₁₂) halogenated or unhalogenated branched alkyl, C₁₋₁₂ (for example, it can be C₁, C₂, C₃, C₄, C₅, C₆, C₇, C₈, C₉, C₁₀, C₁₁ or C₁₂) halogenated or unhalogenated alkoxy, C₂₋₁₂ (for example, it can be C₂, C₃, C₄, C₅, C₆, C₇, C₈, C₉, C₁₀, C₁₁ or C₁₂) halogenated or unhalogenated alkenyl, C₂₋₁₂ (for example, it can be C₂, C₃, C₄, C₅, C₆, C₇, C₈, C₉, C₁₀, C₁₁ or C₁₂) halogenated or unhalogenated alkenoxy,

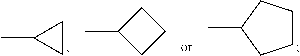

R₂˜R₅ each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁, or C₁₂) branched alkyl, C₁₋₁₂ (for example, it can be C₁, C₂, C₃, C₄, C₅, C₆, C₇, C₈, C₉, C₁₀, C₁₁ or C₁₂) alkoxy, C₂₋₁₂ (for example, it can be C₂, C₃, C₄, C₅, C₆, C₇, C₈, C₉, C₁₀, C₁₁ or C₁₂) alkenyl, C₂₋₁₂ (for example, it can be C₂, C₃, C₄, C₅, C₆, C₇, C₈, C₉, C₁₀, C₁₁ or C₁₂) alkenoxy,

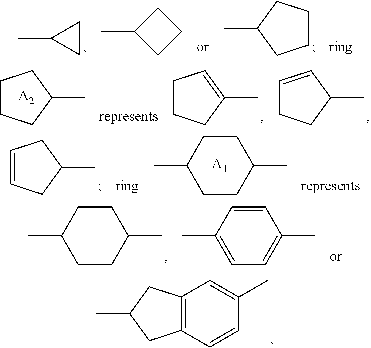

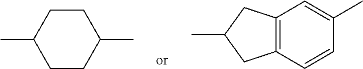

wherein one or at least two —CH2— in can be replaced by —O—, one or at least two single bond in the rings can be replaced by double bond; one or at least two —H on

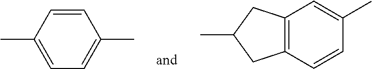

can each be independently replaced by —F, —Cl, —CN, —CH₃ or —OCH₃, one or at least two —CH═ in the rings can be replaced by —N═;
ring

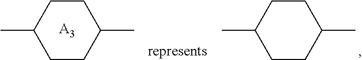

one or at least two —CH₂—in

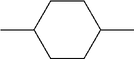

can be replaced by —O—, one or at least two single bond in the rings can be replaced by double bond, and one or at least two single bond in at least one ring

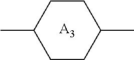

is replaced by double bond;
ring

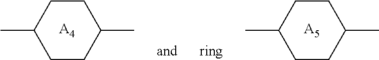

each independently represents

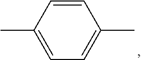

one or at least two —H on

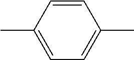

can each be independently replaced by —F, —Cl, —CN, —CH₃ or —OCH₃, one or at least two —CH═ in the rings can be replaced by —N═;
L₁-L₆ each independently represents halogen atom;
X₁ and X₂ each independently represents —O— or —S—;
Z₁ represents single bond, —CO—O—, —O—CO—, —CH₂O—, —OCH₂—, —CH═CH—, —C═C—, —CH₂CH₂—, —CF₂CF₂—, —(CH₂)₄—, —CF₂O— or —OCF₂—;
n₁ represents 0, 1 or 2, when n₁ represents 2, ring

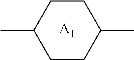

can be the same or different, Z₁ can be the same or different;
n₂ represents 1 or 2, when n₂ represents 2, ring

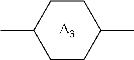

can be the same or different; and
n₃ represents 0, 1, 2 or 3, n₄ represents 0 or 1, and 2≤n₃+n₄≤3; when n₃ represents 2 or 3, ring

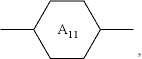

can be the same or different.

Negative liquid crystal monomer compound containing cycloalkenyl groups is a type of relatively new liquid crystal monomer materials in recent years. Compared with conventional negative monomers, negative monomers with cycloalkenyl groups have the advantages of good mutual solubility in liquid crystal mixtures, fast response, large K value and so on, and usually have moderate refractive index and clearing point, which have good effects in both positive and negative liquid crystal materials.

Via using negative compound containing cycloalkenyl groups (the compound of general formula I) in conjunction with the compound of general formula Il and/or the compound of general formula III, the liquid crystal composition prepared in the present invention has an appropriate optical anisotropy, an appropriate clearing point, an appropriate absolute value of dielectric anisotropy, a larger K value (K₁₁, K₃₃), a smaller rotational viscosity, a shorter response time, a higher transmittance, a higher contrast rate and a longer low-temperature storage time as well as excellent mutual solubility, which makes the liquid crystal display device containing the liquid crystal composition of the present invention have a wider using temperature range, a lower threshold voltage, a better contrast rate, a faster response speed, a faster refresh speed and a higher transmittance and suitable for fast-response VA, IPS, NFFS display modes and the like.

In the present invention, the halogen atom includes fluorine atom, chlorine atom, bromine atom and iodine atom (the same below).

The followings are preferred technical solutions of the present invention, but not used as limitations of the technical solutions provided by the present invention. The objections and beneficial effects of the present invention can be better achieved and realized via the following preferred technical solutions.

In some embodiments of the present invention, the compound of general formula I is any one or the combination of at least two of the compounds with the following

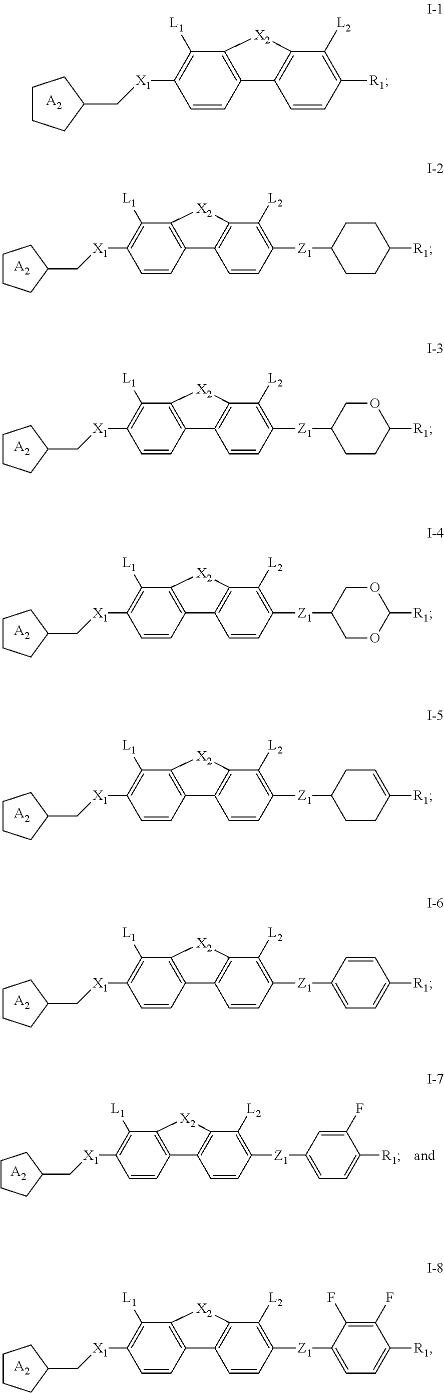

wherein, ring

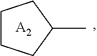

R₁, X₁, X₂, L₁, L₂, and Z₁ have the same protection scopes as aforesaid.

In some embodiments of the present invention, ring

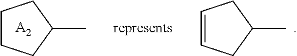

In some embodiments of the present invention, L₁ and L₂ represent fluorine atom.

In some embodiments of the present invention, the compound of general formula I is the compound I-1.

In some embodiments of the present invention, the liquid crystal composition comprises at least two compounds of general formula I.

In some embodiments of the present invention, in the liquid crystal composition, percentage by weight of the compound of general formula I is 0.1%-30%, for example, it can be 0.1%, 0.2%, 0.5%, 1%, 2%, 4%, 6%, 8%, 10%, 12%, 14%, 16%, 18%, 20%, 22%, 24%, 26%, 28%, 30% or the like, further preferably, 1%-20%, still further preferably, 4%-16%.

In some embodiments of the present invention, it is preferred to adjust the content of the compound of general formula I, such that the liquid crystal composition comprising the same has an appropriate optical anisotropy, an appropriate clearing point, an appropriate absolute value of dielectric anisotropy, a larger K value (K₁₁, K₃₃), a smaller rotational viscosity, a shorter response time, a higher transmittance, a higher contrast rate and a longer low-temperature storage time.

In some embodiments of the present invention, the compound of general formula II is any one or the combination of at least two of the compounds with the following structures:

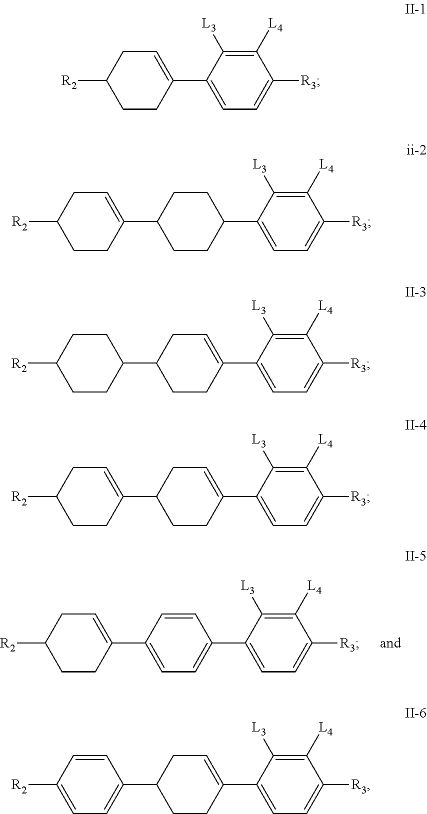

wherein, R₂, R₃, L₃, and L₄ have the same protection scopes as aforesaid.

In some embodiments of the present invention, L₃ and L₄ both represent fluorine atom.

In some embodiments of the present invention, the liquid crystal composition comprises at least two (for example, it can be three or four) compounds of general formula Il.

In some embodiments of the present invention, in the liquid crystal composition, percentage by weight of the compound of general formula II is 0.1%- 50%, for example, it can be 0.1%, 0.2%, 0.5%, 1%, 2%, 5%, 10%, 15%, 20%, 25%, 30%, 36%, 40%, 45%, 50% or the like, further preferably, 15%- 36%.

In some embodiments of the present invention, it is preferred to adjust the content of the compound of general formula II such that the liquid crystal composition comprising the same has an appropriate optical anisotropy, an appropriate clearing point, an appropriate absolute value of dielectric anisotropy, a larger K value (K₁₁, K₃₃), a smaller rotational viscosity, a shorter response time, a higher transmittance, a higher contrast rate and a longer low-temperature storage time.

In some embodiments of the present invention, the compound of general formula III is any one or the combination of at least two of the compounds with the following

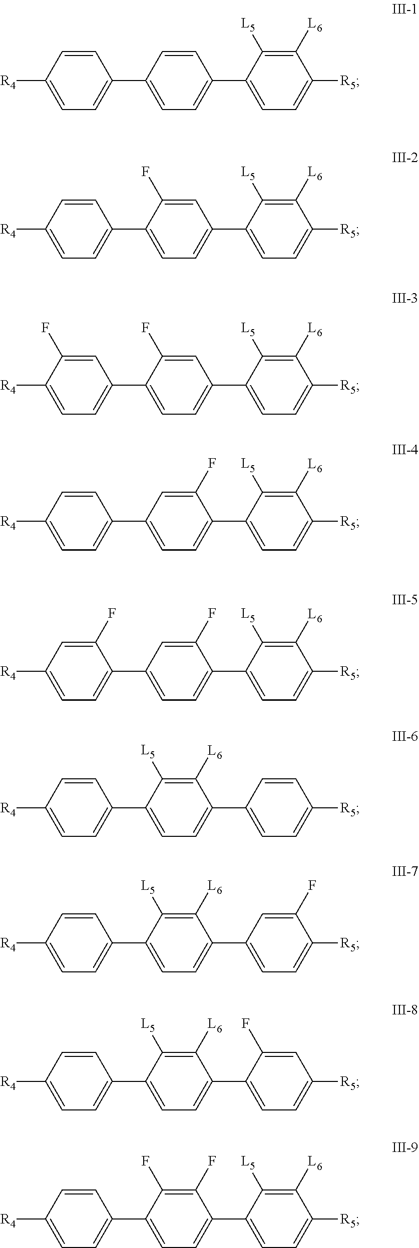

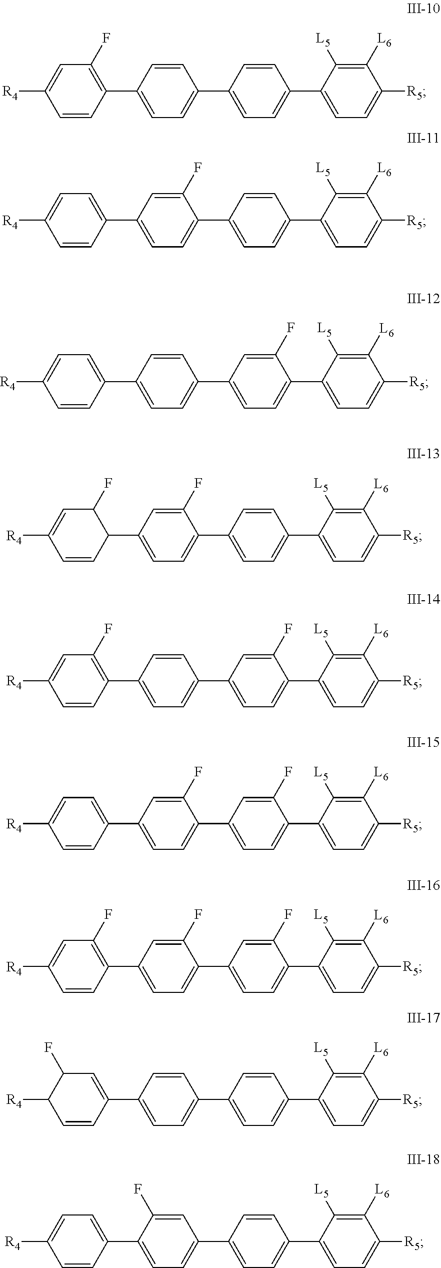

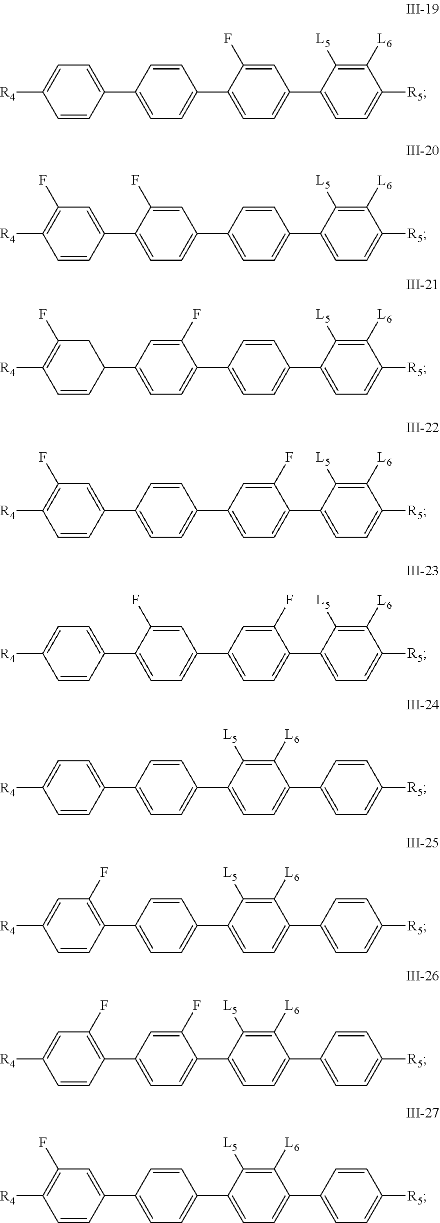

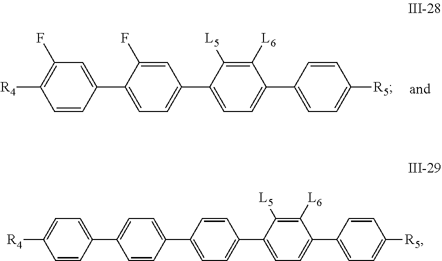

wherein, R₄, R₅, L₅, and L₆ have the same protection scopes as aforesaid; in some embodiments of the present invention, L₅ and L₆ both represent fluorine atom.

In some embodiments of the present invention, the liquid crystal composition comprises at least two (for example, it can be three or four) compounds of general formula III.

In some embodiments of the present invention, the liquid crystal composition comprises at least one (for example, it can be two or three) compounds of general formula III of which R₄ represents C₂₋₁₂ (for example, it can be C₂, C₃, C₄, C₅, C₆, C₇, C₈, C₉, C₁₀, C₁₁ or C₁₂) alkenyl.

In some embodiments of the present invention, in the liquid crystal composition, percentage by weight of the compound of general formula III is 0.1%-30%, for example, it can be 0.1%, 0.2%, 0.5%, 1%, 3%, 5%, 7%, 10%, 12%, 15%, 18%, 20%, 23%, 25%, 27%, 30% or the like, further preferably, 3%- 15%.

In some embodiments of the present invention, it is preferred to adjust the content of the compound of general formula III such that the liquid crystal composition comprising the same has an appropriate optical anisotropy, an appropriate clearing point, an appropriate absolute value of dielectric anisotropy, a larger K value (K₁₁, K₃₃), a smaller rotational viscosity, a shorter response time, a higher transmittance, a higher contrast rate and a longer low-temperature storage time.

In some embodiments of the present invention, the liquid crystal composition further comprises at least one compound of general formula N:

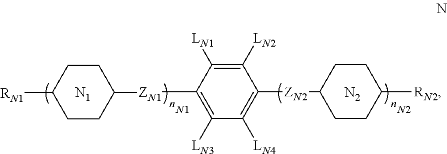

wherein, R_{N1} and R_{N2} each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

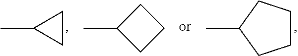

wherein one or at least two nonadjacent —CH₂— in the C₁₋₁₂ linear alkyl and C₃₋₁₂ branched alkyl can each be independently replaced by —CH═CH—, —C≡C—, —O—, —CO—, —CO—O— or —O—CO—;
ring

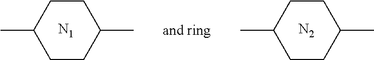

each independently represents

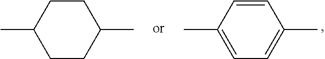

wherein one or at least two —CH₂— in

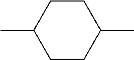

can be replaced by —O—; one or at least two —H on

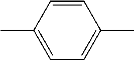

can each be independently replaced by —F, —Cl or —CN, one or at least two —CH═ in the rings can be replaced by —N═;
Z_{N1} and Z_{N2} each independently represents single bond, —CO—O—, —O—CO—, —CH₂O—, —OCH₂—, —CH═CH—, —C≡C—, —CH₂—CH₂—, —CF₂CF₂—, —(CH₂)₄—, —CF₂O— or —OCF₂—;
L_{N1} and L_{N2} each independently represents —H, C₁₋₃ alkyl, or halogen atom;
n_{N1} represents 0, 1, 2 or 3, n_{N2} represents 0 or 1, and 0≤n_{N1}+n_{N2}≤3, wherein when n_{N1} represents 2 or 3, ring

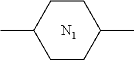

can be the same or different, and Z_{N1} can be the same or different; and
substituted or unsubstituted terphenyl structure is not contained in the compound of general formula N, the substituent for substitution is selected from —F, —Cl or —CN.

In some embodiments of the present invention, the compound of general formula N is any one or the combination of at least two of the compounds with the following

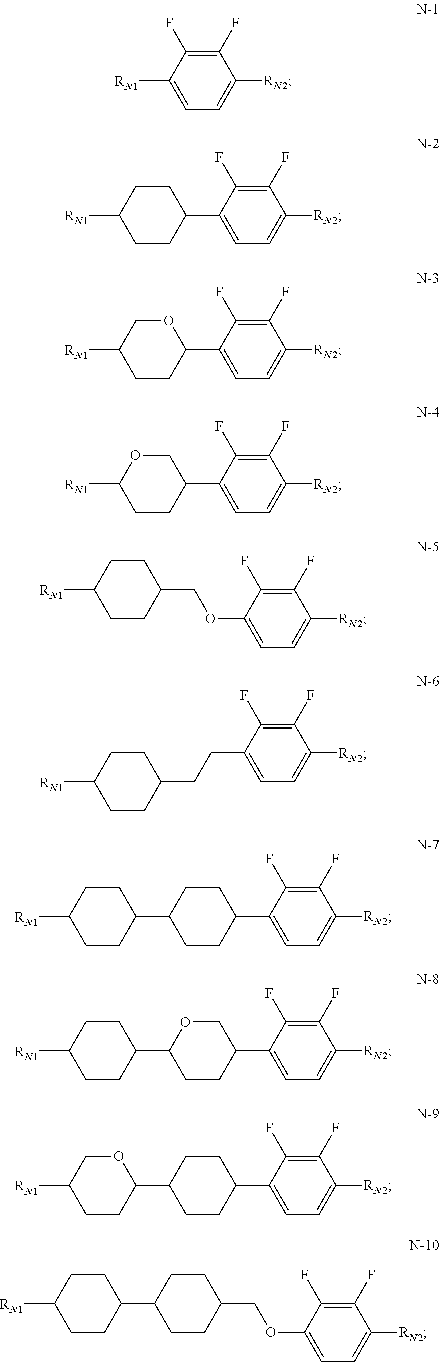

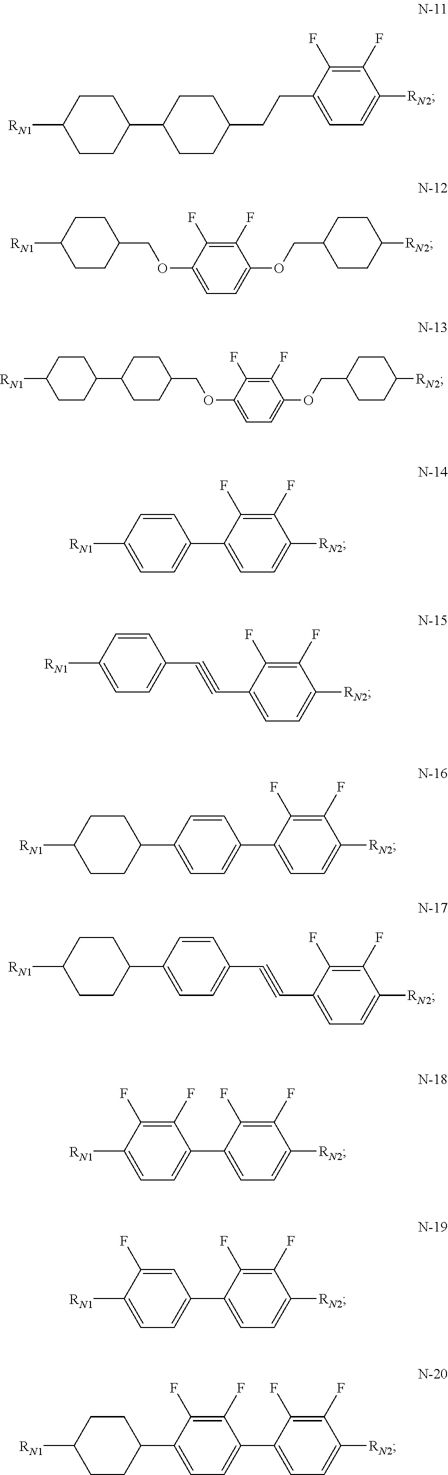

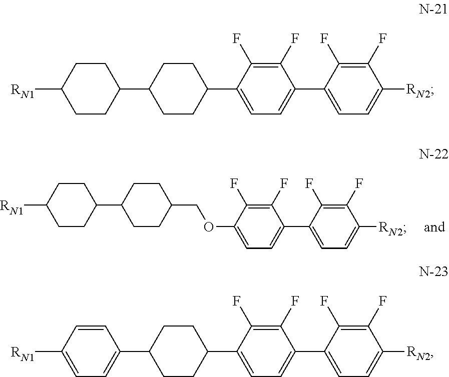

wherein, R_{N1} and R_{N2} have the same protection scopes as aforesaid.

In some embodiments of the present invention, the compound of general formula N is selected from a group consisting of the compound of general formula N-2, the compound of general formula N-5, the compound of general formula N-10, the compound of general formula N-14, the compound of general formula N-16, and the compound of general formula N-19. In some embodiments of the present invention, in the liquid crystal composition, percentage by weight of the compound of general formula N is 0.1%-30%, for example, it can be 0.1%, 0.2%, 0.5%, 1%, 2%, 5%, 7%, 10%, 12%, 15%, 18%, 20%, 23%, 25%, 27%, 30% or the like, further preferably, 5%- 25%.

In some embodiments of the present invention, it is preferred to adjust the content of the compound of general formula N such that the liquid crystal composition comprising the same has an appropriate optical anisotropy, an appropriate clearing point, an appropriate absolute value of dielectric anisotropy, a larger K value (K₁₁, K₃₃), a smaller rotational viscosity, a shorter response time, a higher transmittance, a higher contrast rate and a longer low-temperature storage time.

In some embodiments of the present invention, the liquid crystal composition further comprises at least one compound of general formula M:

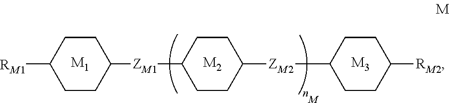

wherein, R_{M1} and R_{M2} each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

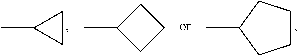

wherein one or at least two nonadjacent —CH₂— in the C₁₋₁₂ linear alkyl and C₃₋₁₂ branched alkyl can each be independently replaced by —CH═CH—, —C≡C—, —O—, —CO—, —CO—O— or —O—CO—;
ring

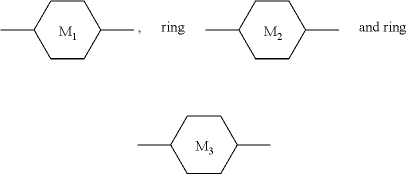

each independently represents

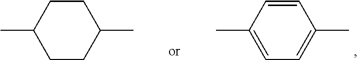

wherein one or at least two —CH₂— in

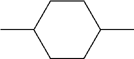

can be replaced by —O—, one or at least two single bond in the rings can
be replaced by double bond; at most one —H on

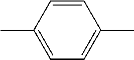

can be replaced by halogen atom;
Z_{M1} and Z_{M2} each independently represents single bond, —CO—O—, —O—CO—, —CH₂O—, —OCH₂—, —C≡C—, —CH—CH—, —CH₂CH₂— or —(CH₂)₄—; and
n_{M} represents 0, 1 or 2, wherein when nM represents 2, ring

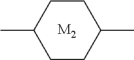

can be the same or different, Z_{M2} can be the same or different.

In some embodiments of the present invention, the compound of general formula M is any one or the combination of at least two of the compounds with the following

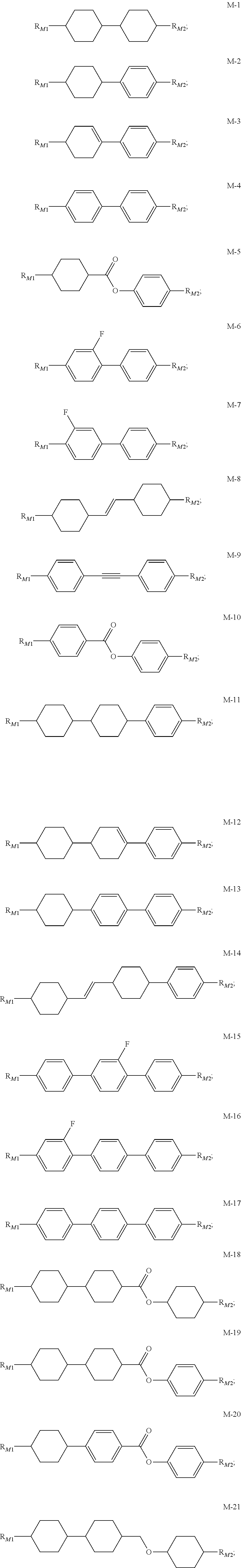

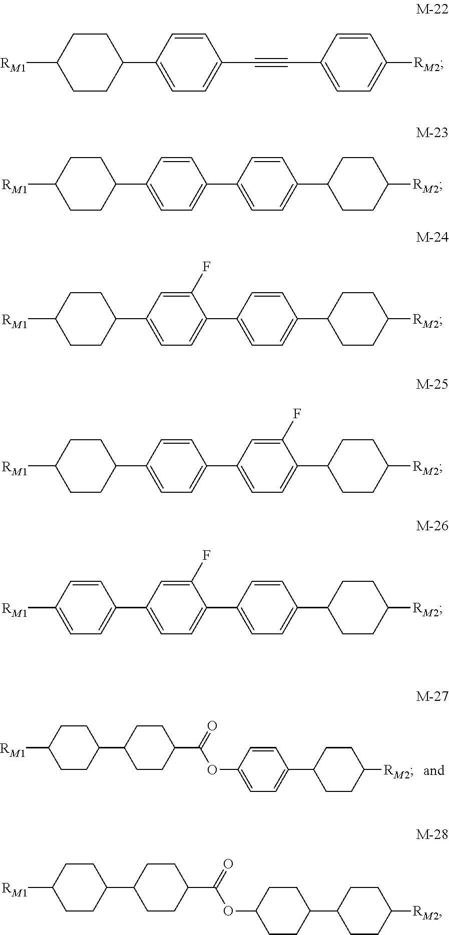

wherein, R_{M1} and R_{M2} have the same protection scopes as aforesaid.

In some embodiments of the present invention, the compound of general formula M is selected from a group consisting of the compound of general formula M-1, the compound of general formula M-2, the compound of general formula M-4, the compound of general formula M-13, the compound of general formula M-15, and the compound of general formula M-28.

In some embodiments of the present invention, in the liquid crystal composition, percentage by weight of the compound of general formula M is 0.1%- 60%, for example, it can be 0.1%, 0.2%, 0.5%, 1%, 2%, 5%, 10%, 15%, 20%, 25%, 30%, 35%, 40%, 45%, 50%, 55%, 60% or the like, further preferably, 30%-50%.

In some embodiments of the present invention, the liquid crystal composition further comprises at least one compound of general formula B:

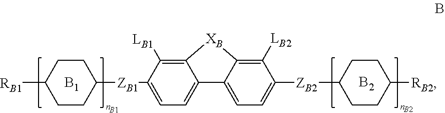

wherein, R_{B1} and R_{B2} each independently represents halogen atom, C₁₋₁₂ (for example, it can be C₁, C₂, C₃, C₄, C₅, C₆, C₇, C₈, C₉, C₁₀, C₁₁ or C₁₂) halogenated or unhalogenated linear alkyl, C₃₋₁₂ (for example, it can be C₃, C₄, C₅, C₆, C₇, C₈, C₉, C₁₀, C₁₁ or C₁₂) halogenated or unhalogenated branched alkyl,

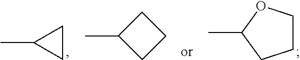

wherein one or at least two nonadjacent —CH₂— in C₁₋₁₂ halogenated or unhalogenated linear alkyl, C₃₋₁₂ halogenated or unhalogenated branched alkyl,

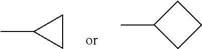

can each independently be replaced by —CH═CH—, —CH═CF—, —C≡C—, —O —, —CO—, —CO—O— or —O—CO—;
ring

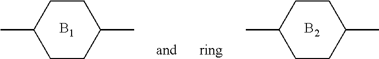

each independently represents

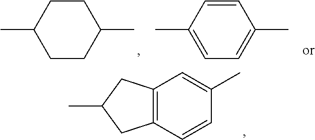

wherein one or at least two nonadjacent —CH₂— in

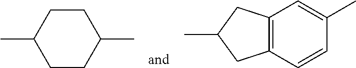

can be replaced by —O—, one or at least two single bond in the rings can be replaced by double bond; one or at least two —H on

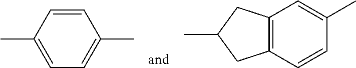

can each be independently replaced by —CN, —F or —Cl, one or at least two —CH═ in the rings can be replaced by —N═;
X_{B} represents —O—, —S— or —CO—;
L_{B1} and L_{B2} each independently represents —H, —F, —Cl, —CF₃ or —OCF₃;
Z_{B1} and Z_{B2} each independently represents single bond, —CO—O—, —O—CO—, —CH₂O—, —OCH₂—, —CH═CH—, —C≡C—, —CH₂CH₂—, —CF₂CF₂—, —(CH₂)n_{B4}—, —(CH₂)n_{B4}O—, —(CH₂)n_{B4}S—, —CF₂O— or —OCF₂—, wherein n_{B4} represents an integer of 0-5 (for example, it can be 0, 1, 2, 3, 4 or 5);
n_{B1} and n_{B2} each independently represents 0, 1 or 2, wherein when n_{B1} represents 2, ring

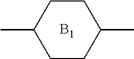

can be same or different, when n_{B2} represents 2, ring

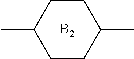

can be same or different, Z_{B2} can be same or different.

In some embodiments of the present invention, the compound of general formula B is any one or the combination of at least two of the compounds with the following

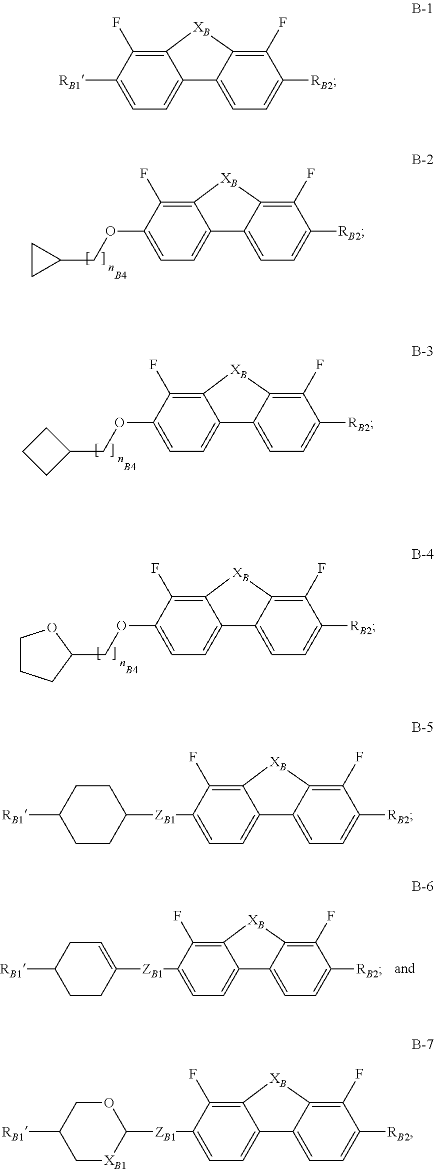

wherein, R_{B1}′ represents C₁₋₈ (for example, it can be C₁, C₂, C₃, C₄, C₅, C₆, C₇ or C₈) alkyl, C₁₋₈ (for example, it can be C₁, C₂, C₃, C₄, C₅, C₆, C₇ or C₈) alkoxy, C₂₋₈ (for example, it can be C₂, C₃, C₄, C₅, C₆, C₇ or C₈) alkenyl;
X_{B1} represents —O— or —CH₂—;
R_{B2}, X_{B} and Z_{B1} have the same protection scopes as aforesaid.

In some embodiments of the present invention, the compound of general formula B-1 is any one or the combination of at least two of the compounds with the following structures:

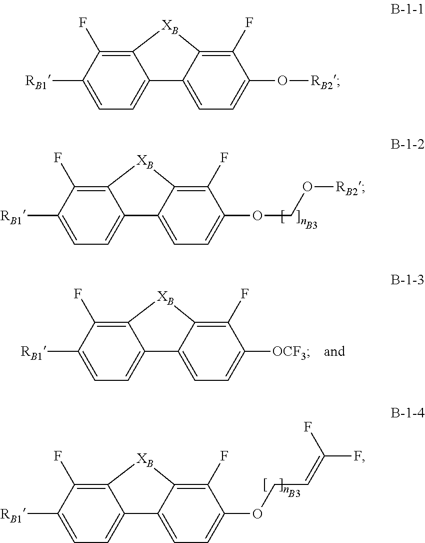

wherein, R_{B2}′ represents C₁₋₈ (for example, it can be C₁, C₂, C₃, C₄, C₅, C₆, C₇ or C₈) alkyl;
R_{B1}′, X_{B} and n_{B4} have the same protection scopes as aforesaid;
n_{B3} represents 1, 2, 3 or 4;
n_{B5} represents 0, 1, 2, 3 or 4.

In some embodiments of the present invention, in the liquid crystal composition, percentage by weight of the compound of general formula B is 0.1%- 20%, for example, it can be 0.1%, 0.2%, 0.5%, 1%, 2%, 4%, 5%, 7%, 8%, 10%, 12%, 14%, 16%, 18%, 20% or the like, further preferably, 1%-10%

In some embodiments of the present invention, in order to apply the liquid crystal composition of the present application into liquid crystal display devices with high transmittance, the liquid crystal composition further comprises at least one compound of general formula A-1 and/or at least one compound of general formula A-2:

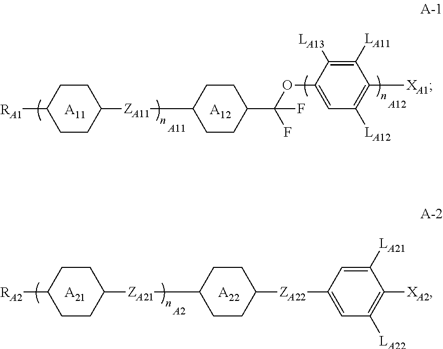

wherein, R_{A1} and R_{A2} each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

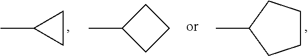

wherein, one or at least two nonadjacent —CH₂— in the C₁₋₁₂ linear alkyl, C₃₋₁₂ branched alkyl,

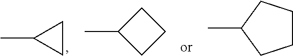

can each be independently replaced by —CH═CH—, —C≡C—, —O—, —CO—, —CO—O— or —O—CO—, and one or at least two —H in the C₁₋₁₂ linear alkyl and C₃₋₁₂ branched alkyl can each be independently replaced by —F or —Cl;
ring

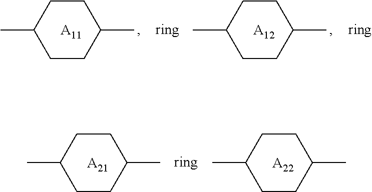

each independently represents

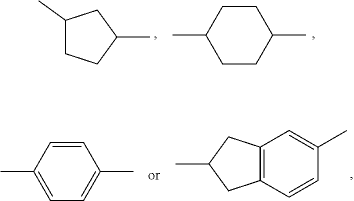

wherein one or at least two —CH₂— in

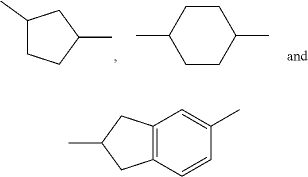

can be replaced by —O—, one or at least two single bond in the rings can be replaced by double bond; one or at least two —H on

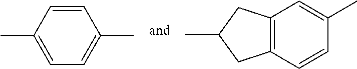

can each be independently replaced by —F, —Cl or —CN, one or at least two —CH═ in the rings can be replaced by —N═;
ZA₁₁, ZA₂₁ and ZA₂₂ each independently represents single bond, —CH₂CH₂—, —CF₂CF₂—, —CO—O—, —O—CO—, —O—CO—O—, —CH═CH—, —CF═CF—, —CH₂O— or —OCH₂—;
LA₁₁, LA₁₂, LA₁₃, LA₂₁ and LA₂₂ each independently represents —H, C₁₋₃ (for example, it can be C₁, C₂ or C₃) alkyl or halogen atom;
XA₁ and XA₂ each independently represents halogen atom, C₁₋₅ (for example, it can be C₁, C₂, C₃, C₄ or C₅) halogenated alkyl, C₁₋₅ (for example, it can be C₁, C₂, C₃, C₄ or C₅) halogenated alkoxy, C₂₋₅ (for example, it can be C₂, C₃, C₄ or C₅) halogenated alkenyl, C₂₋₅ (for example, it can be C₂, C₃, C₄ or C₅) halogenated alkenoxy;
n_{A11} represents 0, 1, 2 or 3, wherein when nA11 represents 2 or 3, ring

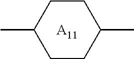

can be same or different, and Z_{A11} can be same or different;
n_{A12} represents 1 or 2, wherein when n_{A12} represents 2, ring

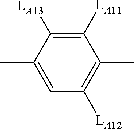

can be same or different;
n_{A2} represents 0, 1, 2 or 3, wherein when nA2 represents 2 or 3, ring

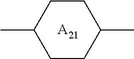

can be same or different, and Z_{A21} can be the same or different.

In some embodiments of the present invention, the compound of general formula A-1 is any one or the combination of at least two of the compounds with the following

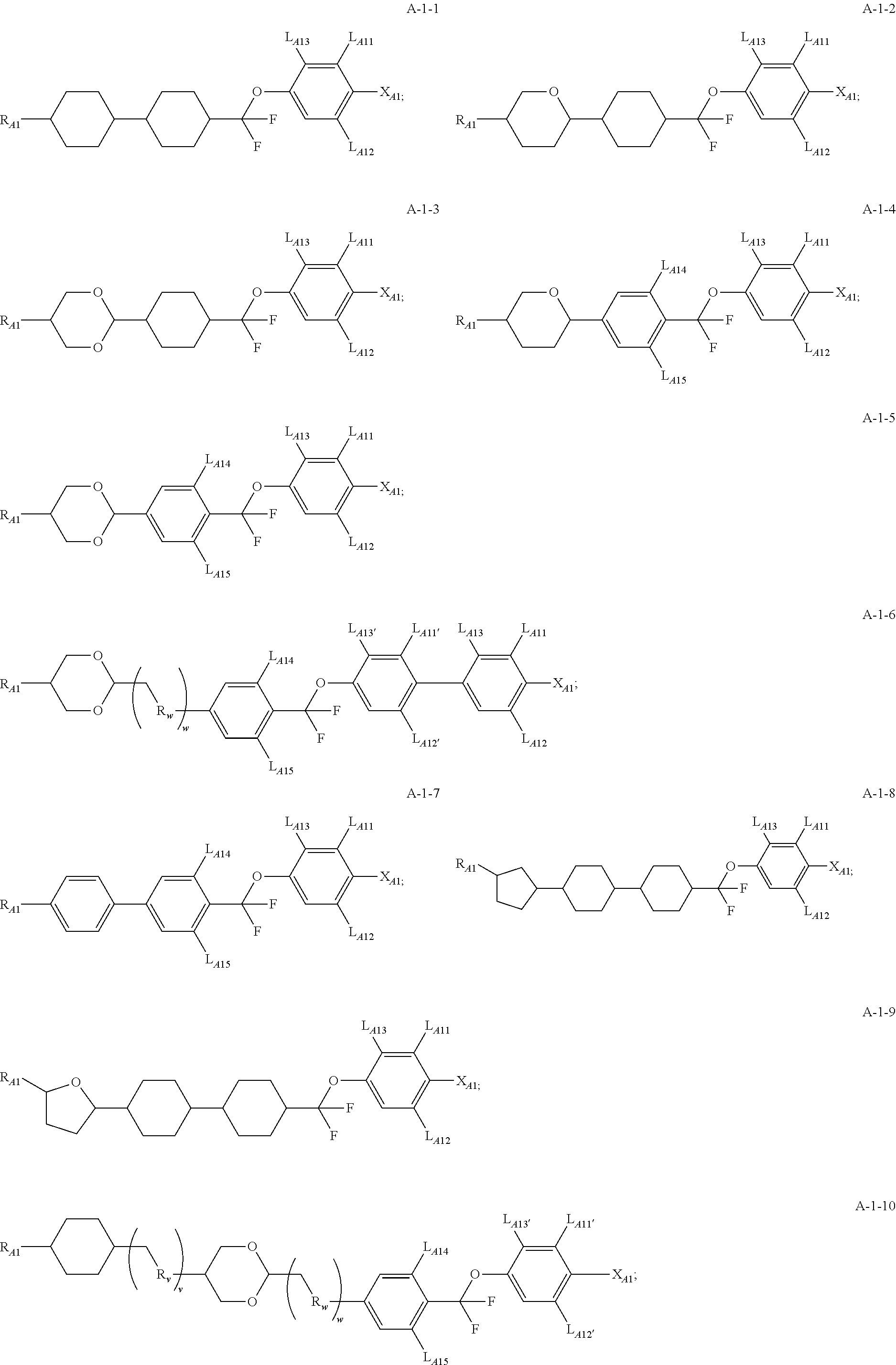

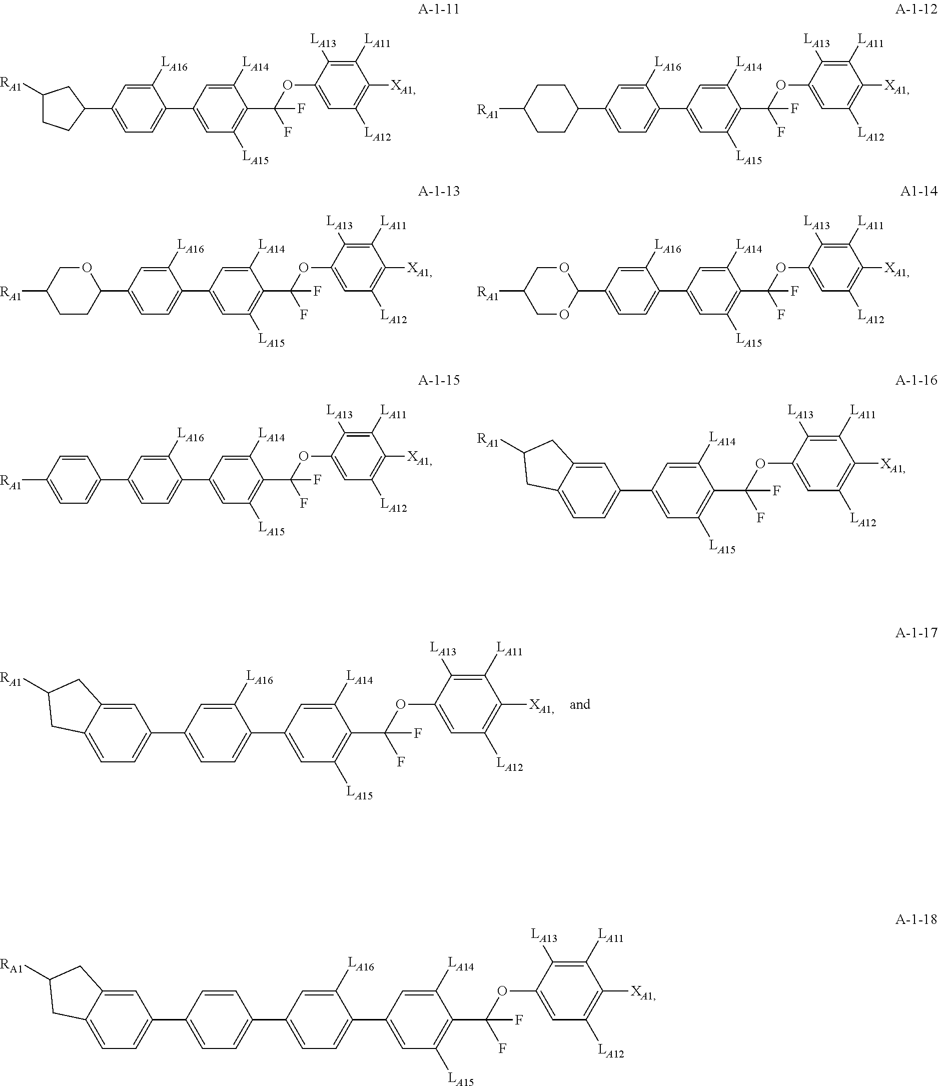

wherein, R_{A1} represents C₁₋₈ (for example, it can be C₁, C₂, C₃, C₄, C₅, C₆, C₇ or C₈) linear alkyl, C₃₋₈ (for example, it can be C₃, C₄, C₅, C₆, C₇ or C₈) branched alkyl,

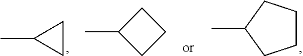

wherein one or at least two nonadjacent —CH₂— in the C1-8 linear alkyl and C3-8 branched alkyl can each be independently replaced by —CH═CH—, —C≡C—, —O—, —CO—, —CO—O— or —O—CO—, and one or at least two —H in the C1-8 linear alkyl, C3-8 branched alkyl

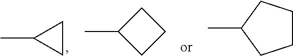

can each be independently replaced by —F or —Cl;
Rᵥ and R_{w} each independently represents —CH₂— and —O—;
v and w each independently represents 0 or 1;
L_{A11}, L_{A12}, L_{A11}′, L_{A12}′, L_{A14}, L_{A15} and L_{A16} each independently represents —H or —F;
L_{A13} and L_{A13}′ each independently represents —H or —CH₃; and
X_{A1} represents —F, —CF₃ or —OCF₃.

In some embodiments of the present invention, in the liquid crystal composition, percentage by weight of the compound of general formula A-1 is 0.1%- 50%, for example, it can be 0.1%, 1%, 4%, 6%, 8%, 10%, 12%, 14%, 16%, 18%, 20%, 22%, 24%, 26%, 28%, 30%, 32%, 34%, 36%, 38%, 40%, 42%, 44%, 46%, 48%, 50% or the like.

In some embodiments of the present invention, the compound of general formula A-2 is any one or the combination of at least two of the compounds with the following

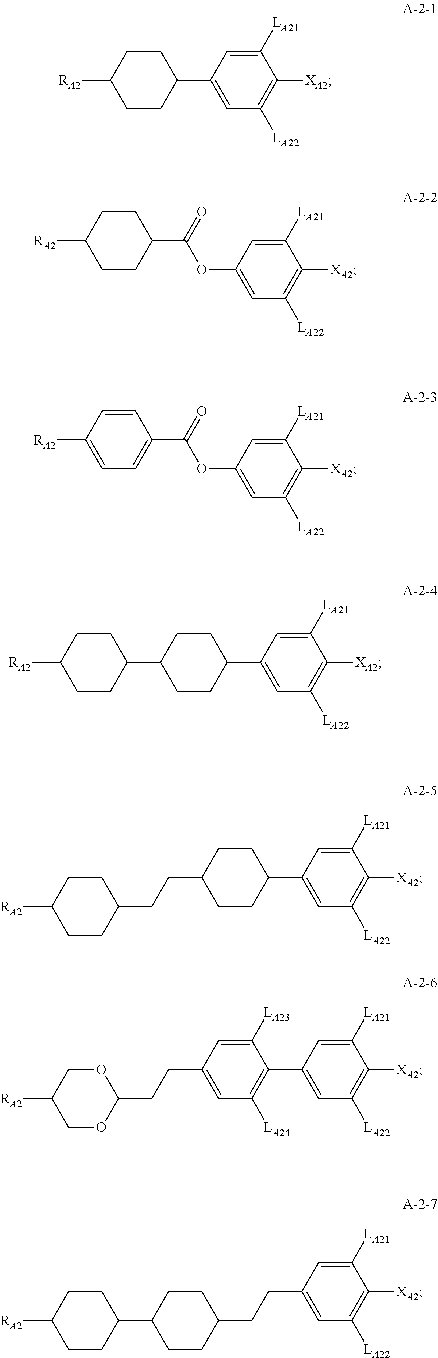

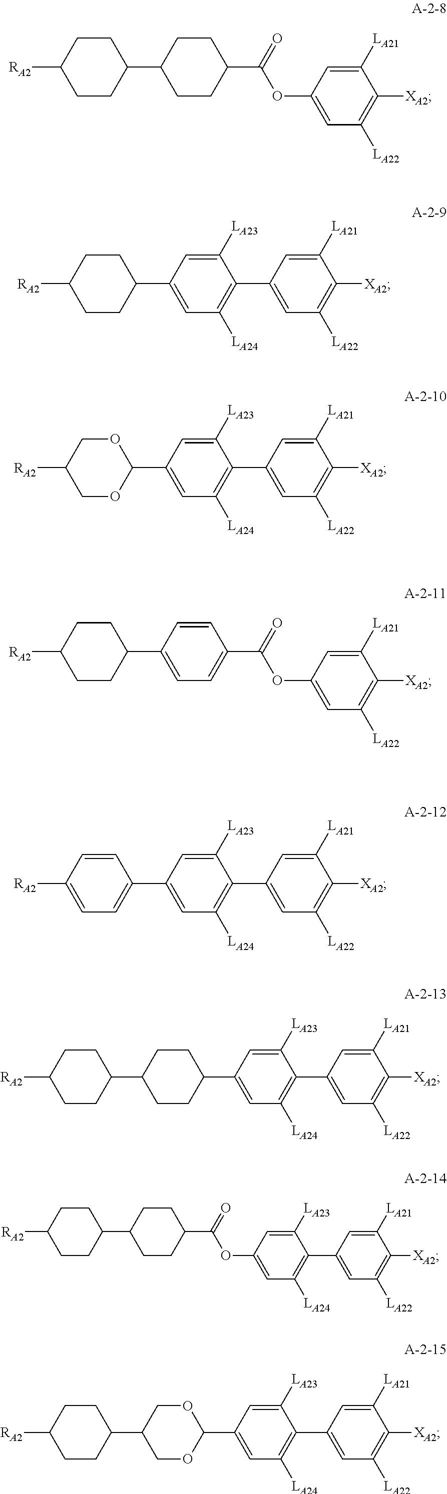

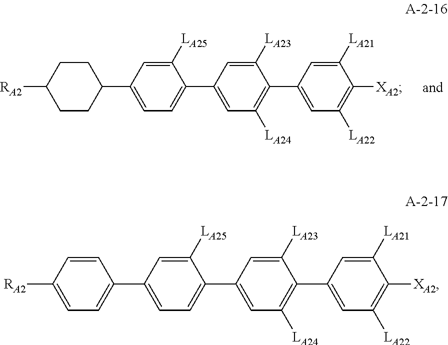

wherein, R_{A2} represents C₁₋₈ (for example, it can be C₁, C₂, C₃, C₄, C₅, C₆, C₇ or C₈) linear alkyl, C₃₋₈ (for example, it can be C₃, C₄, C₅, C₆, C₇ or C₈) branched alkyl, wherein one or at least two nonadjacent —CH₂— in the C₁₋₈ linear alkyl and C₃₋₈ branched alkyl can each be independently replaced by —CH═CH—, —C≡C—, —O—, —CO—, —CO—O— or —O—CO—, and one or at least two —H in the C₁₋₈ linear alkyl and C₃₋₈ branched alkyl can each be independently replaced by —F or —Cl;
L_{A21}, L_{A22}, L_{A23}, L_{A24} and L_{A25} each independently represents —H or —F; and
X_{A2} represents —F, —CF3, —OCF₃ or —CH₂CH₂CH═CF₂.

In some embodiments of the present invention, in the liquid crystal composition, percentage by weight of the compound of general formula A-2 is 0.1%- 50%, for example, it can be 0.1%, 1%, 4%, 6%, 8%, 10%, 12%, 14%, 16%, 18%, 20%, 22%, 24%, 26%, 28%, 30%, 32%, 34%, 36%, 38%, 40%, 42%, 44%, 46%, 48%, 50% or the like.

In some embodiments of the present invention, in the liquid crystal composition, sum of percentages by weight of the compound of general formula A-1 and the compound of general formula A-2 is 0.1%-60%, for example, it can be 0.1%, 1%, 4%, 6%, 8%, 10%, 12%, 14%, 16%, 18%, 20%, 22%, 24%, 26%, 28%, 30%, 32%, 34%, 36%, 38%, 40%, 42%, 44%, 46%, 48%, 50%, 52%, 54%, 56%, 58%, 60% or the like.

In some embodiments of the present invention, the liquid crystal composition further comprises at least one polymerizable compound of general formula RM:

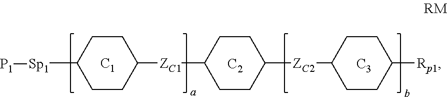

wherein, Rₚ₁ represents —H, halogen atom, —CN, —Sp₂—P₂, C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

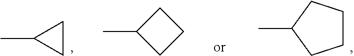

wherein one or at least two nonadjacent —CH₂— in C₁₋₁₂ linear alkyl, C₃₋₁₂ branched alkyl,

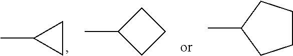

can each be independently replaced by —CH═CH—, —C≡C—, —O—, —CO—, —CO—O— or —O—CO—, and one or at least two —H can each be independently replaced by —F or —Cl;
ring

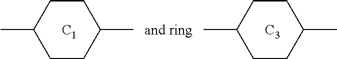

each independently represents

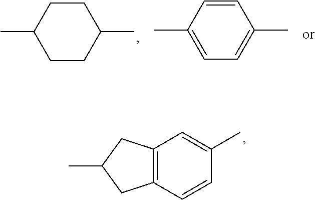

wherein one or at least two —CH₂— in

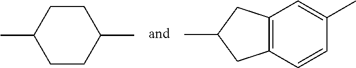

can be replaced by —O—, one or at least two single bond in the rings can be replaced by double bond; one or at least two —H on

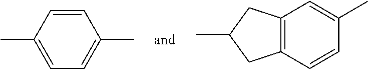

can each be independently replaced by —F, —Cl, —CN, —Sp₃—P₃, C₁₋₁₂ (for example, it can be C₁, C₂, C₃, C₄, C₅, C₆, C₇, C₈, C₉, C₁₀, C₁₁ or C₁₂) halogenated or unhalogenated linear alkyl, C₁₋₁₁ (for example, it can be C₁, C₂, C₃, C₄, C₅, C₆, C₇, C₈, C₉, C₁₀ or C₁₁) halogenated or unhalogenated linear alkoxy,

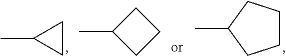

and one or at least two —CH═ in the rings can be replaced by —N═;
ring

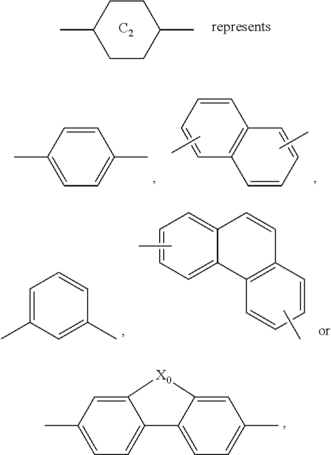

wherein one or at least two-H on ring

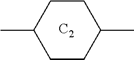

can each be independently replaced by —F, —Cl, —CN, —Sp₃—P₃, C₁₋₁₂ (for example, it can be C₁, C₂, C₃, C₄, C₅, C₆, C₇, C₈, C₉, C₁₀, C₁₁ or C₁₂) halogenated or unhalogenated linear alkyl, C₁₋₁₁ (for example, it can be C₁, C₂, C₃, C₄, C₅, C₆, C₇, C₈, C₉, C₁₀ or C₁₁) halogenated or unhalogenated linear alkoxy,

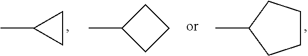

one or at least two —CH═ in the rings can each be independently replaced by —N═, X₀ represents —O—, —S—, —CO—, —CF₂—, —NH— or —NF—;
P₁, P₂ and P₃ each independently represents polymerizable group;
Sp₁, Sp₂ and Sp₃ each independently represents spacer group or single bond;
Z_{C1} and Z_{C2} each independently represents —O—, —S—, —CO—, —CO—O—, —O—CO—, —O—CO—O—, —CH₂O—, —OCH₂—, —CH₂S—, —SCH₂—, —CF₂O—, —OCF₂—, —CF₂S—, —SCF₂—, —(CH₂)_{d}—, —CF₂CH₂—, —CH₂CF₂—, —(CF₂)_{d}—, —CH═CH—, —CF═CF—, —CH═CF—, —CF═CH—, —C≡C—, —CH═CH—CO—O—, —O—CO—CH═CH—, —CH₂CH₂—CO—O—, —O—CO—CH₂CH₂—, —CHR¹—, —CR¹R²— or single bond, wherein R¹ and R² each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl, and d represents an integer of 1-4 (for example, it can be 1, 2, 3 or 4);
a represents 0, 1 or 2, b represents 0 or 1, wherein when a represents 2, ring

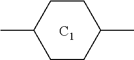

can be the same or different, and Z_{C1} can be the same or different.

The polymerizable groups involved in the present invention are groups suitable for polymerization reactions (for example, radical or ionic bond polymerization, addition polymerization or condensation polymerization), or groups suitable for addition or condensation on the polymer backbone. For chain polymerization, a polymerizable group containing —CH═CH— or —C≡C— is particularly preferred, and for ring-opening polymerization, for example, an oxetane or epoxy group is particularly preferred.

In some embodiments of the present invention, the polymerizable groups P₁, P₂ and P₃ each independently represents

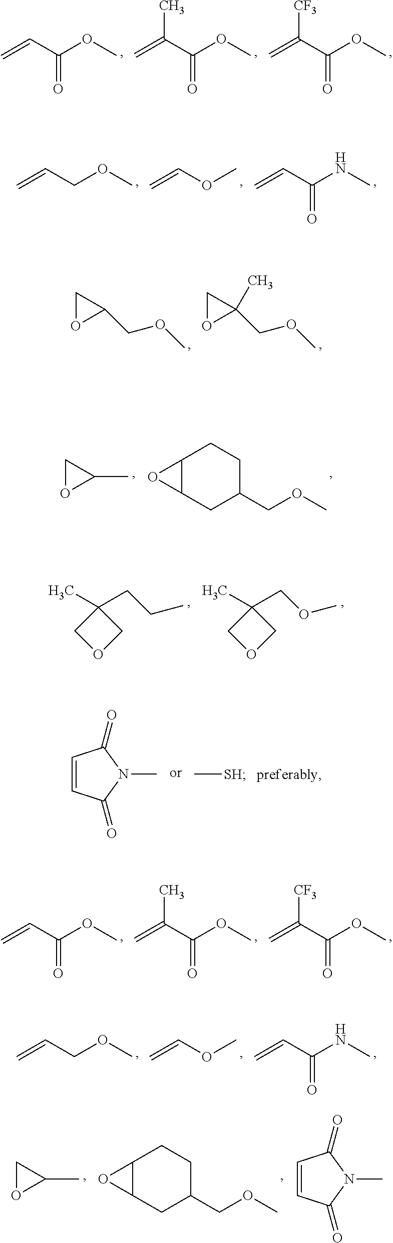

or —SH; further preferably,

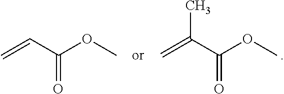

It should be noted that the term “spacer group” is known to the person skilled in the art and is described in the references (for example, Pure Appl. Chem. 2001,73(5),888 and C. Tschierske, G. Pelzl, S. Diele, Angew. Chem. 2004, 116, 6340-6368). As used herein, the term “spacer group” represents a flexible group which connects the mesogenic group and the polymerizable group in a polymerizable compound. For example, —(CH₂)p₁—, —(CH₂CH₂O)q₁—CH₂CH₂—, —(CH₂CH₂S)q₁—CH₂CH₂—, —(CH₂CH₂NH)q₁—CH₂CH₂—, —CR⁰R⁰⁰—(CH₂)p₁— or —(SiR⁰R⁰⁰-O)p₁— are representative spacer groups, wherein p₁ represents an integer of 1-12, q₁ represents an integer of 1-3, R⁰ and R⁰⁰ each independently represents —H, C₁₋₁₂ linear or branched alkyl, or C₃₋₁₂ cyclic alkyl. In the present invention, the preferred spacer group is —(CH₂)p₁—, —(CH₂)p₁—O—, —(CH₂)p₁—O—CO—, —(CH₂)p₁—CO—O—, —(CH₂)p₁—O—CO—O— or —CR⁰R⁰⁰—(CH₂)p₁—.

In some embodiments of the present invention, the compound of general formula RM is any one or the combination of at least two of the compounds with the following structures:

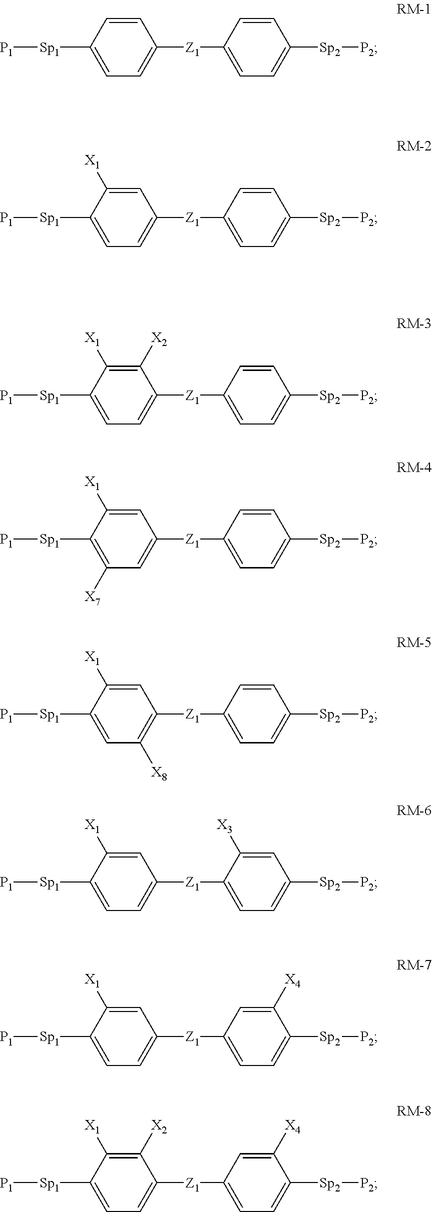

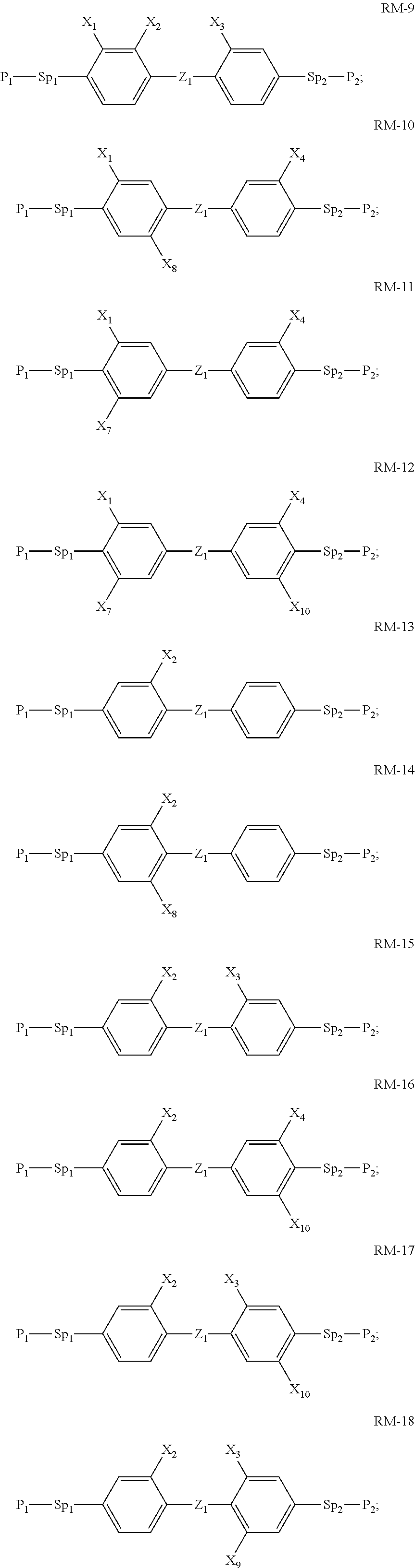

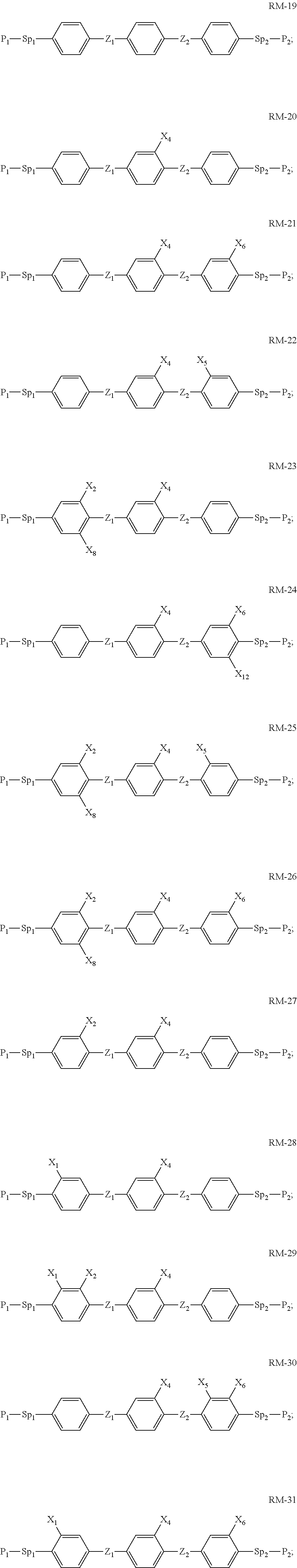

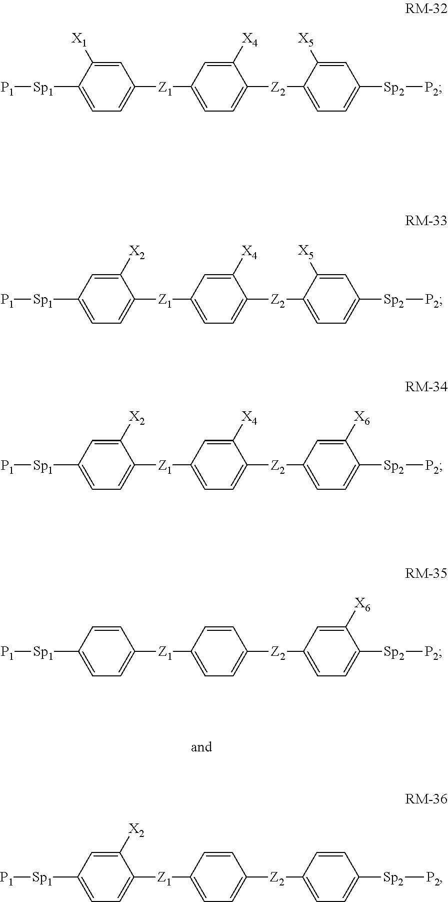

wherein, X₁-X₁₀ and X₁₂ each independently represents —F, —Cl, —Sp₃—P₃, C₁₋₅ (for example, it can be C₁, C₂, C₃, C₄ or C₅) linear alkyl, C₁₋₅ (for example, it can be C₁, C₂, C₃, C₄ or C₅) alkoxy,

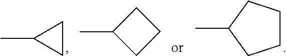

In some embodiments of the present invention, in the liquid crystal composition, percentage by weight of the polymerizable compound of general formula RM is 0.001%- 5%, for example, 0.001%, 0.002%, 0.004%, 0.005%, 0.006%, 0.008%, 0.01%, 0.02%, 0.04%, 0.06%, 0.08%, 0.1%, 0.2%, 0.25%, 0.26%, 0.27%, 0.28%, 0.29%, 0.3%, 0.32%, 0.33%, 0.34%, 0.35%, 0.4%, 0.5%, 0.6%, 0.8%, 1%, 1.2%, 1.6%, 1.8%, 2%, 2.5%, 3%, 3.5%, 4%, 4.5%, 5% or the like.

In some embodiments of the present invention, the liquid crystal composition further comprises at least one additive.

The additives contain nematic liquid crystal, smectic liquid crystal, cholesteric liquid crystal, dopants, antioxidant, ultraviolet absorber, infrared absorber, polymerizable monomer or light stabilizer.

In some embodiments of the present invention, the dopant comprises any one or the combination of at least two of the following compounds:

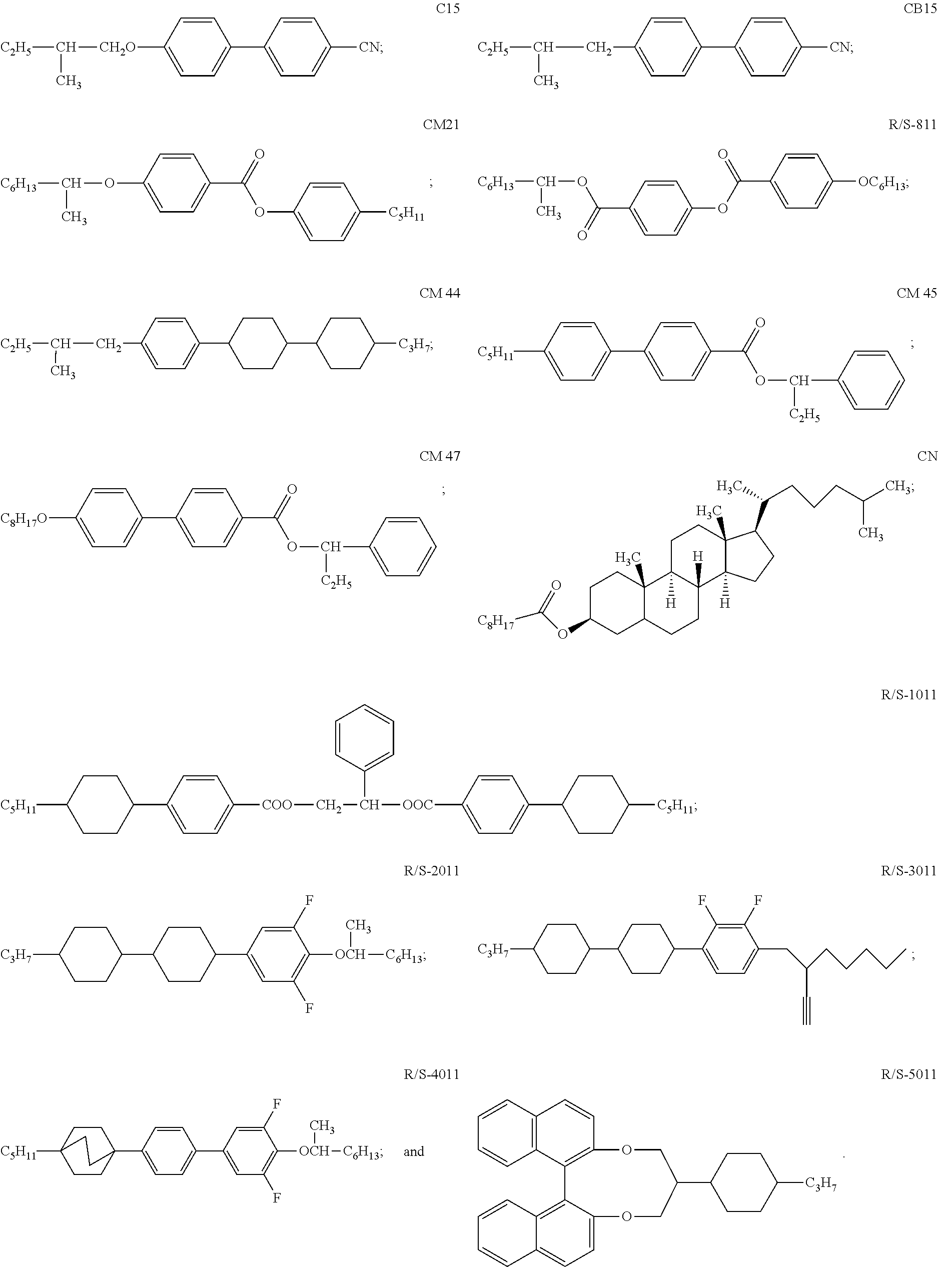

In some embodiments of the present invention, in the liquid crystal composition, percentage by weight of the dopant is 0%- 5% for example, it can be 0%, 0.01%, 0.05%,, 0.1%, 0.2%, 0.5%, 1%, 1.5%, 2%, 2.5%, 3%, 3.5%, 4%, 4.5%, 5%, or the like, further preferably, 0.01%-1%.

In some embodiments of the present invention, additives (such as antioxidant, light stabilizer, ultraviolet absorber and the like) are preferably to be the following compounds:

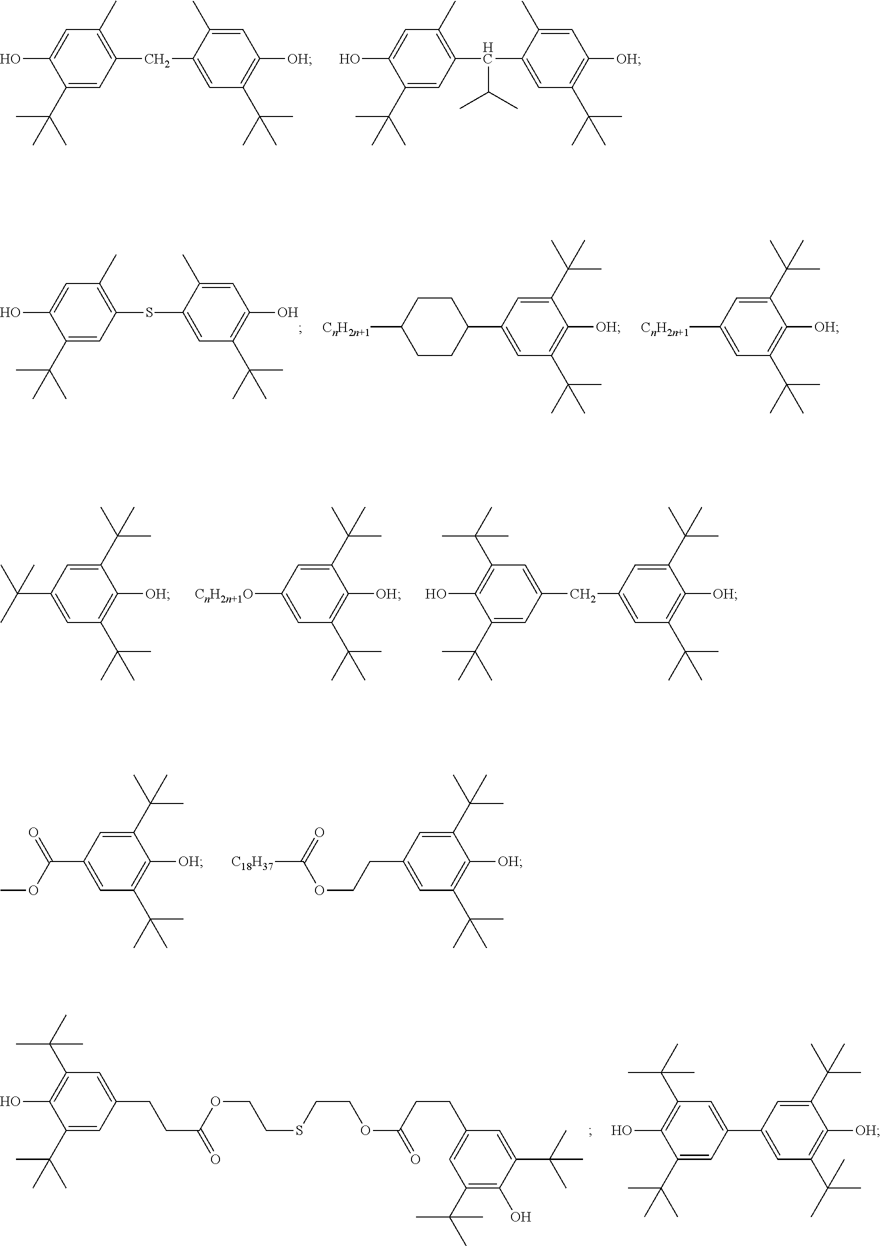

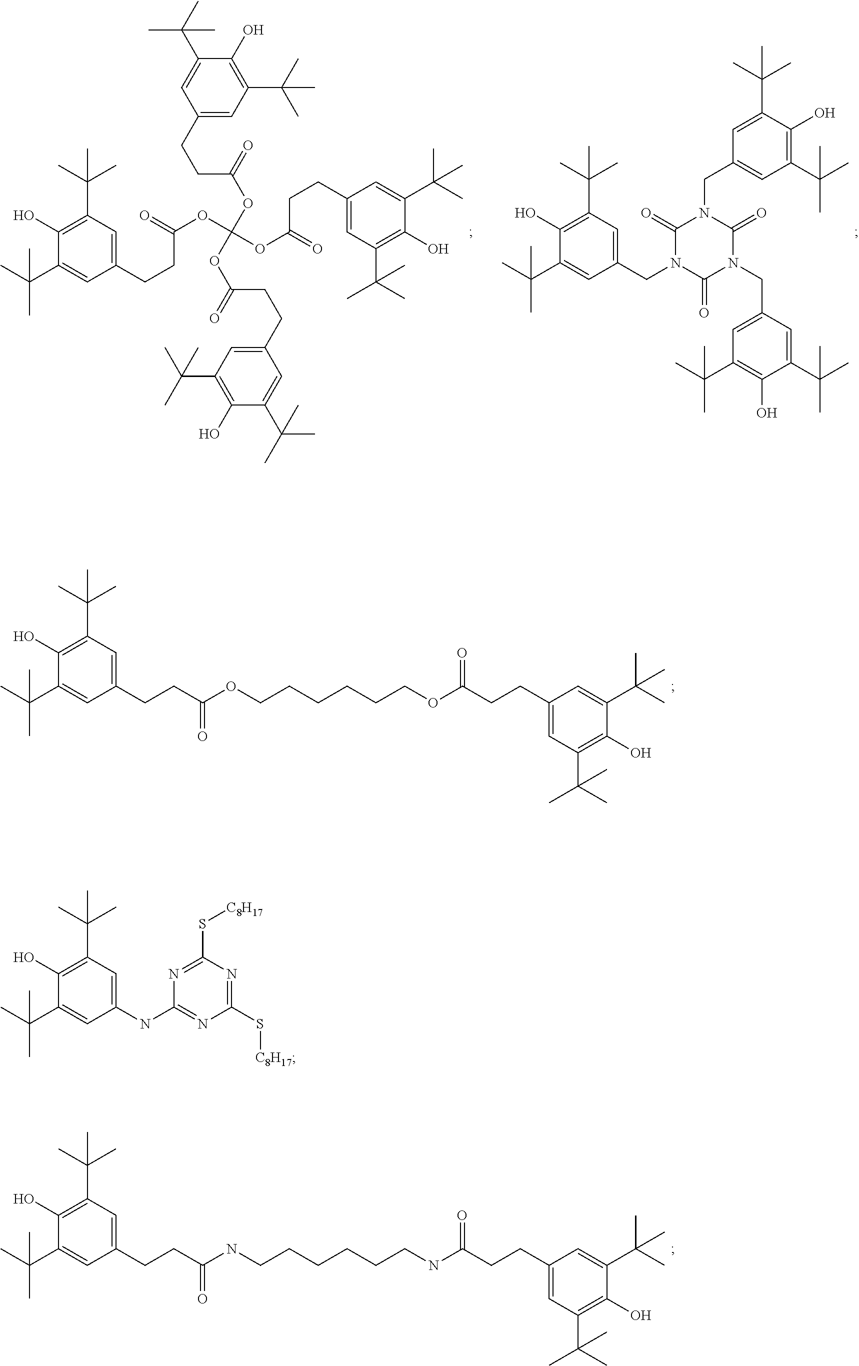

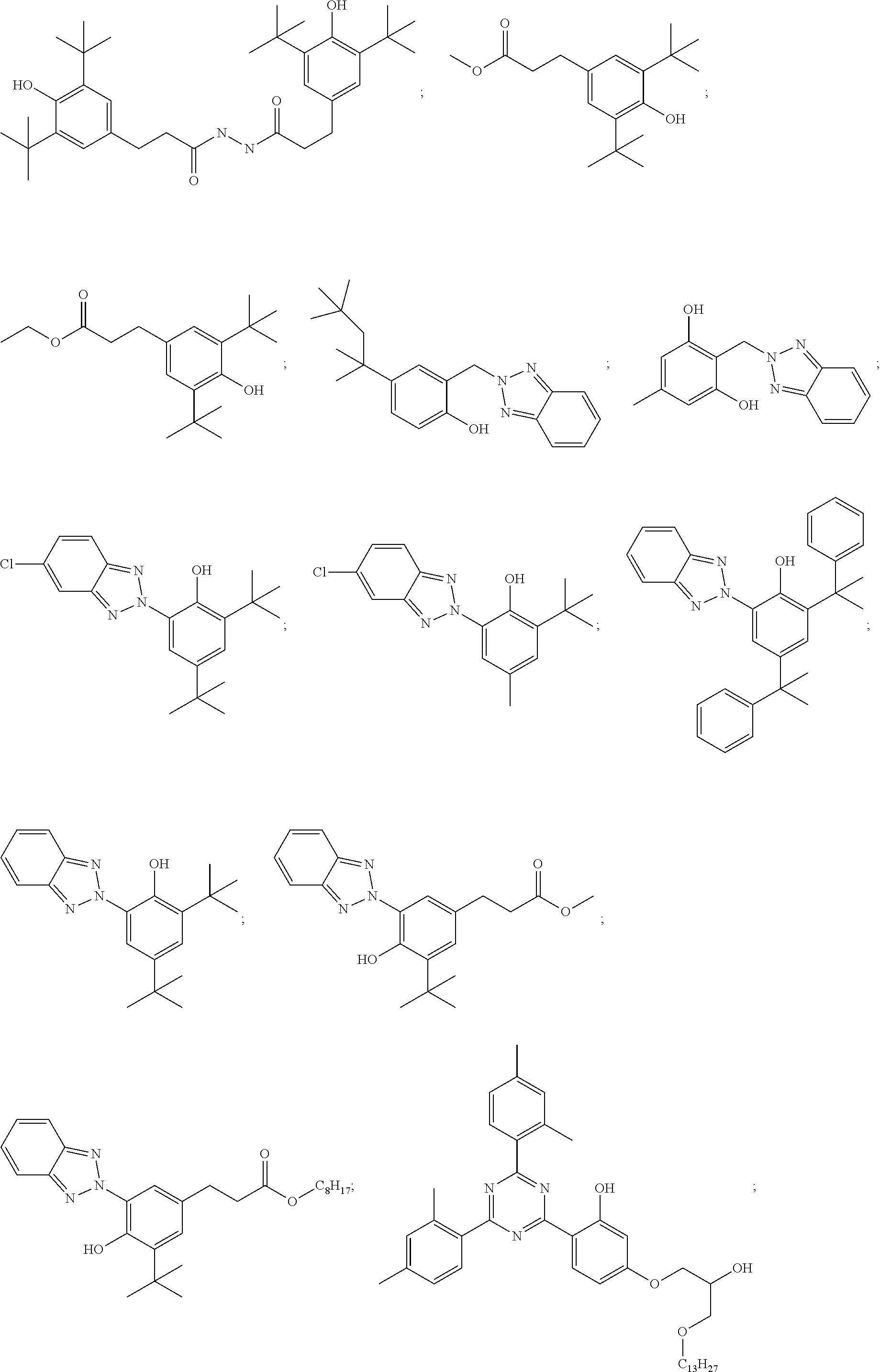

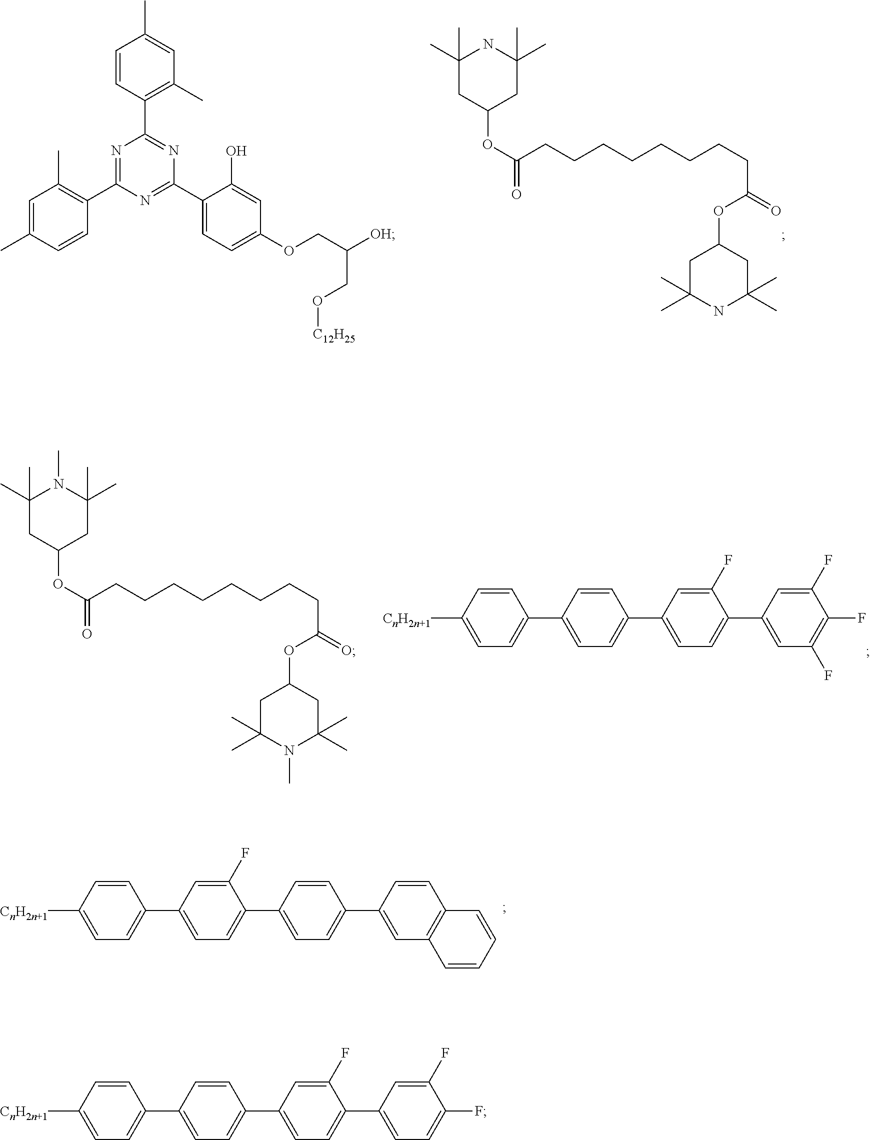

wherein, n represents a positive integer of 1-12, for example, it can be 1, 2, 4, 6, 8, 9, 10, 11, 12 or the like.

In some embodiments of the present invention, the antioxidant is selected from any one or the combination of at least two of the following compounds:

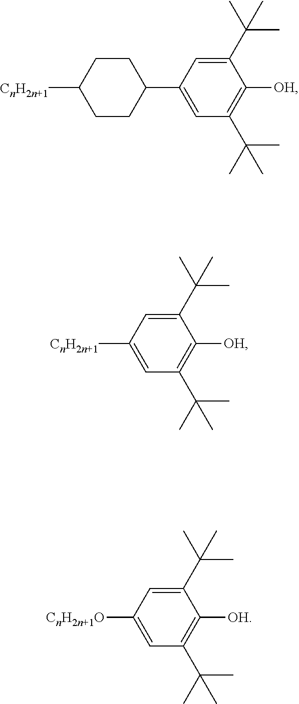

In some embodiments of the present invention, in the liquid crystal composition, percentage by weight of the light stabilizer is 0%-5%, for example, it can be 0%, 0.01%. 0.05%, 0.1%, 0.2%, 0.5%, 1%, 1.5%, 2%, 2.5%, 3%, 3.5%, 4%, 4.5%, 5% or the like, further preferably, 0.01%-1%.

It should be noted that, for an easier calculation, in the present invention, the sum of the weight percentages of the compounds having different general formulas in the liquid crystal composition is one hundred percent, and the content of the additives is not counted within the total content of the liquid crystal composition, that is, the addition of the additives will result in the total content of the components in the liquid crystal composition being >100%.

In some embodiments of the present invention, the liquid crystal composition further comprises a polymerization initiator, exemplarily including, but not limited to: benzoin ethers, benzophenones, acetophenones, benzoin bis-ethers, acyl phosphine oxides and so forth.

In a second aspect, the present invention provides a liquid crystal display device. and the liquid crystal display device comprises a liquid crystal composition as described in the first aspect.

Compared with the prior art, the present invention has the following beneficial effects:

Via designing the specific constitution of the liquid crystal composition, and further using the compound of general formula I containing cycloalkenyl groups in conjunction with the compound of general formula II and the compound of general formula III, the liquid crystal composition prepared in the present invention has an appropriate optical anisotropy, an appropriate clearing point, an appropriate absolute value of dielectric anisotropy, a larger K value, a smaller rotational viscosity, a shorter response time, a higher transmittance, a higher contrast rate and a longer low-temperature storage time, which makes the liquid crystal display device containing the liquid crystal composition of the present invention have a wider using temperature range, a lower threshold voltage, a better contrast rate, a faster response speed, a faster refresh speed and a higher transmittance and suitable for fast-response, high-contrast VA, IPS, NFFS display modes and the like.

### DETAILED EMBODIMENTS

For an easier understanding of the present invention, the present invention enumerates the Examples below. It should be clear for the person skilled in the art that, the Examples are only for helping to understand the present invention, and shall not be seen as specific limitations on the present invention.

For the convenience of the expression, in the following examples, the group structures of the liquid crystal composition are represented by the codes listed in Table 1:

TABLE 1

| Unit structure of group | Code | Name of group |
|---|---|---|
| 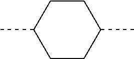 | C | 1,4-cyclohexylidene |
| 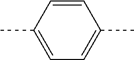 | P | 1,4-phenylene |
| 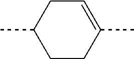 | L | 1, 4-cyclohexene |
| 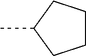 | C(5) | 1-cyclopentyl |
| 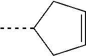 | C(5,V) | 1-cyclopentenyl |
| 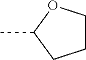 | THF | tetrahydrofuran-2-yl |
| 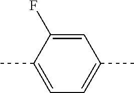 | G′ | 3-fluoro-1,4-phenylene |
| 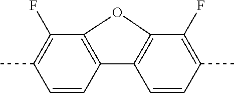 | B(O) | 4,6-difluoro-dibenzo[b,d]furan-3,7-diyl |
| 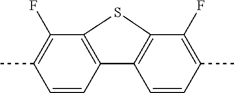 | B(S) | 4,6-difluoro-dibenzo[b,d]thiophene-3,7-diyl |
| 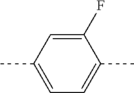 | G | 2-fluoro-1,4-phenylene |
| 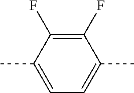 | W | 2,3-difluoro-1,4-phenylene |
| —O— | O | oxygen substituent |
| —F | F | fluorine substituent |
| —CH═CH— or —CH═CH₂ | V | ethenylene or ethenyl |
| 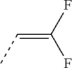 | V(2F) | difluoroenyl |
| —COO— | E | ester bridge bond |
| —CH₂O— | 1O | methyleneoxy |
| —CH₂CH₂— | 2 | ethyl bridge group |
| —C₂H_{2n + 1} or —CₙH₂ₙ— | n (n represents a positive integer of 1-12) | alkyl or alkylene |

In Table 1, broken lines represent the binding sites of the groups.

Take the compound with the following structural formula as an example:

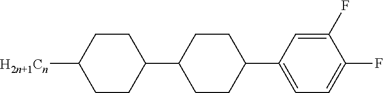

represented by the codes listed in Table 1, this structural formula can be expressed as nCCGF, n in the code represents the number of the carbon atoms of the alkyl on the left, for example, n is “3”, meaning that the alkyl is —C₃H₇; C in the code represents cyclohexylidene, G represents 2-fluoro-1,4-phenylene, and F represents fluorine.

In the following Examples and Comparative Examples, the abbreviated codes of performance test items are shown in Table 2:

TABLE 2
The abbreviated codes of the performance test items

| Code of | |
|---|---|
| test items | Meaning |
| Cp | clearing point (nematic-isotropy phases transition |
| | temperature, ° C.) |
| Δn | optical anisotropy (589 nm, 20° C.) |
| Δε | dielectric anisotropy (1 KHz, 20° C.) |
| K₁₁ | splay elastic constant |
| K₃₃ | bend elastic constant |
| γ₁ | rotational viscosity (20° C.)/mPa · s |
| τ | response time (ms) |
| Tᵣ | transmittance (%) |
| CR | contrast rate |
| LTS(−40° C.) | low-temperature storage stability (stored at −40° C. and |
| | the time when crystal precipitation is observed, h) |

wherein, Δn: tested using an Abbe Refractometer under a sodium lamp (589 nm) light source at 20° C.;
Cp (° C.): tested by melting point apparatus quantitative method;
Δε: Δε=ε//−ε⊥, in which, ε// is the dielectric constant parallel to the molecular axis, ε⊥ is the dielectric constant perpendicular to the molecular axis, test conditions: 20° C., 1 KHz, VA-type test cell with a cell gap of 6 μm;
K₁₁, K₃₃: K₁₁ and K₃₃ are obtained via testing the capacitance-voltage characteristic curves (C-V curves) of liquid crystal by LCR meter and VA test cell and calculating; test conditions: 6 μm VA test cell, V=0.1˜20 V;
γ₁: tested using a LCM-2 type liquid crystal physical property evaluation system; test conditions: 20° C., 160-240 V, the cell gap is 20 μm;
τ: tested using a DMS505 tester at 25° C.; test conditions: 20° C., V100 driving, negative IPS-type test cell with a cell gap of 3.5 μm;

Tᵣ: using DMS 505 photoelectric integrated tester to test the V-T curve of dimming device, taking the maximum value of transmittance on the V-T curve as the transmittance of the liquid crystal, the test cell is of negative IPS-type, the cell gap is 3.5 μm;
CR: testing the transmittance of the liquid crystal cell at a 255 gray level voltage and a 0 gray level voltage separately using DMS 505 tester, that is, Tᵣ₂₅₅ and Tᵣ₀, and it is obtained through Tᵣ₂₅₅/Tᵣ₀, test conditions: 20° C., negative IPS-type test cell with a cell gap of 3.5 μm;
LTS: nematic phase liquid crystal medium was placed in a 6 um VA test cell, stored at a constant temperature of −40° C., the time recorded when crystal precipitation is observed.

### Comparative Example 1

The present Comparative Example provides a liquid crystal composition comprising components in the percentages by weight as shown in the table below, and the performance tests are carried out by filling the same into the two substrates of the liquid crystal display device:

| | | |
|---|---|---|
| | | Test result of performance |
| Code of component | Content | parameters |

| | | | |
|---|---|---|---|
| 3CWO2 (N-2) | 17 | Δn | 0.108 |
| 3CLWO2 (II-3) | 8 | Cp | 72 |
| 4CLWO2 (II-3) | 8 | Δε | −3.5 |
| 5CLWO2 (II-3) | 8 | K₁₁ | 14.8 |
| 3CCV (M-1) | 21 | K₃₃ | 16.4 |
| 3CCV1 (M-1) | 12 | γ₁ | 71 |
| 1PP2V (M-4) | 8 | τ | 23.6 |
| 3PPWO2 (III-1) | 2 | Tr | 15.2 |
| 4PPWO2 (III-1) | 2 | CR | 1310 |
| 5PPWO2 (III-1) | 2 | LTS(−40° C.) | 120 |
| 2OB(S)O1C(5) | 6 | | |
| 4OB(S)O1C(5) | 6 | | |

### Comparative Example 2

The present Comparative Example provides a liquid crystal composition comprising components in the percentages by weight as shown in the table below, and the performance tests are carried out by filling the same into the two substrates of the liquid crystal display device:

| | | |
|---|---|---|
| | | Test result of performance |
| Code of component | Content | parameters |

| | | | |
|---|---|---|---|
| 3CWO2 (N-2) | 17 | Δn | 0.103 |
| 3CCWO2 (N-7) | 8 | Cp | 68 |
| 4CCWO2 (N-7) | 8 | Δε | −3.5 |
| 5CCWO2 (N-7) | 8 | K₁₁ | 13.6 |
| 3CCV (M-1) | 21 | K₃₃ | 14.4 |
| 3CCV1 (M-1) | 12 | γ₁ | 66 |
| 1PP2V (M-4) | 8 | τ | 25.1 |
| 3PPWO2 (III-1) | 2 | Tr | 14.1 |
| 4PPWO2 (III-1) | 2 | CR | 1142 |
| 5PPWO2 (III-1) | 2 | LTS(−40° C.) | 168 |
| 2OB(S)O1C(5) | 6 | | |
| 4OB(S)O1C(5) | 6 | | |

### Comparative Example 3

The present Comparative Example provides a liquid crystal composition comprising components in the percentages by weight as shown in the table below, and the performance tests are carried out by filling the same into the two substrates of the liquid crystal display device:

| | | |
|---|---|---|
| | | Test result of performance |
| Code of component | Content | parameters |

| | | | |
|---|---|---|---|
| 3CWO2 (N-2) | 17 | Δn | 0.103 |
| 3CLWO2 (II-3) | 8 | Cp | 75 |
| 4CLWO2 (II-3) | 8 | Δε | −3.4 |
| 5CLWO2 (II-3) | 8 | K₁₁ | 15.1 |
| 3CCV (M-1) | 21 | K₃₃ | 17 |
| 3CCV1 (M-1) | 12 | γ₁ | 73 |
| 1PP2V (M-4) | 8 | τ | 24.1 |
| 3CPWO2 (N-16) | 2 | Tr | 14.2 |
| 4CPWO2 (N-16) | 2 | CR | 1195 |
| 5CPWO2 (N-16) | 2 | LTS(−40° C.) | 168 |
| 2OB(S)O1C(5) | 6 | | |
| 4OB(S)O1C(5) | 6 | | |

### Example 1

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CWO2 (N-2) | 17 | Δn | 0.11 |
| 3CLWO2 (II-3) | 8 | Cp | 74 |
| 4CLWO2 (II-3) | 8 | Δε | −3.5 |
| 5CLWO2 (II-3) | 8 | K₁₁ | 15.6 |
| 3CCV (M-1) | 21 | K₃₃ | 17.7 |
| 3CCV1 (M-1) | 12 | γ₁ | 70 |
| 1PP2V (M-4) | 8 | τ | 23.2 |
| 3PPWO2 (III-1) | 2 | Tr | 15.5 |
| 4PPWO2 (III-1) | 2 | CR | 1430 |
| 5PPWO2 (III-1) | 2 | LTS(−40° C.) | 168 |
| 2OB(S)O1C(5, V) (I-1) | 6 | | |
| 4OB(S)O1C(5, V) (I-1) | 6 | | |

It can be seen from the comparison of Comparative Examples 1-3 and Example 1 that via the optimization of the structures of the compound of general formula I, the compound of general formula II and the compound of general formula III, the liquid crystal composition of the present invention has a better optical anisotropy, a higher clearing point, an appropriate absolute value of dielectric anisotropy, a larger K value (K₁₁, K₃₃), an appropriate rotational viscosity, a shorter response time, a higher transmittance, a better contrast rate and a comparable, even better low-temperature storage stability.

### Example 2

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CWO2 (N-2) | 17 | Δn | 0.099 |
| 3LCWO2 (II-2) | 8 | Cp | 72 |
| 4LCWO2 (II-2) | 8 | Δε | −3.6 |
| 5LCWO2 (II-2) | 8 | K₁₁ | 15.4 |
| 3CCV (M-1) | 21 | K₃₃ | 17.6 |
| 3CCV1 (M-1) | 12 | γ₁ | 67 |
| 1PP2V (M-4) | 8 | τ | 23 |
| 3PG′WO2 (III-2) | 2 | Tr | 15.7 |
| 4PG′WO2 (III-2) | 2 | CR | 1457 |
| 5PG′WO2 (III-2) | 2 | LTS(−40° C.) | 216 |
| 2OB(O)O1C(5, V) (I-1) | 6 | | |
| 3OB(O)O1C(5, V) (I-1) | 6 | | |

### Example 3

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CWO2 (N-2) | 17 | Δn | 0.108 |
| 3CLWO2 (II-3) | 8 | Cp | 73 |
| 4CLWO2 (II-3) | 8 | Δε | −3.4 |
| 5CLWO2 (II-3) | 8 | K₁₁ | 15.2 |
| 3CCV (M-1) | 21 | K₃₃ | 17.2 |
| 3CCV1 (M-1) | 12 | γ₁ | 70 |
| 1PP2V (M-4) | 8 | τ | 23.8 |
| 3PWP2 (III-6) | 2 | Tr | 15.3 |
| 4PWP2 (III-6) | 2 | CR | 1414 |
| 5PWP2 (III-6) | 2 | LTS(−40° C.) | 168 |
| 2OB(S)O1C(5, V) (I-1) | 6 | | |
| 4OB(S)O1C(5, V) (I-1) | 6 | | |

### Example 4

The present Example provides a liquid crystal composition comprising components in the percentages by weight as shown in the table below, and the performance tests are carried out by filling the same into the two substrates of the liquid crystal display device:

| | | Test result performance | |
|---|---|---|---|
| Code of component | Content | parameters | |
| 3CWO2 (N-2) | 9 | Δn | 0.118 |
| 3CLWO2 (II-3) | 9 | Cp | 75 |
| 4CLWO2 (II-3) | 9 | Δε | −3.6 |
| 5CLWO2 (II-3) | 8 | K₁₁ | 16.3 |
| 3CCV (M-1) | 33 | K₃₃ | 18.8 |
| 1PP2V (M-4) | 8 | γ₁ | 72 |
| 2PPWO2 (III-1) | 2 | τ | 22.6 |
| 3PPWO2 (III-1) | 2 | Tr | 16.7 |
| 4PPWO2 (III-1) | 2 | CR | 1556 |
| 5PPWO2 (III-1) | 2 | LTS(−40° C.) | 144 |
| 2OB(S)O1C(5, V) (I-1) | 8 | | |
| 4OB(S)O1C(5, V) (I-1) | 8 | | |

### Example 5

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CWO2 (N-2) | 15 | Δn | 0.11 |
| 3CPWO2 (N-16) | 9 | Cp | 75 |
| 3LCWO2 (II-2) | 5 | Δε | −3.7 |
| 4LCWO2 (II-2) | 5 | K₁₁ | 15.2 |
| 5LCWO2 (II-2) | 5 | K₃₃ | 17.2 |
| 3CCV (M-1) | 24 | γ₁ | 67 |
| 3CCV1 (M-1) | 12 | τ | 23.3 |
| 1PP2V (M-4) | 5 | Tr | 15.4 |
| 3PGWO2 (III-4) | 2 | CR | 1408 |
| 4PGWO2 (III-4) | 2 | LTS(−40° C.) | 168 |
| 5PGWO2 (III-4) | 2 | | |
| 1OB(S)O1C(5, V) (I-1) | 7 | | |
| 2OB(S)O1C(5, V) (I-1) | 7 | | |

### Example 6

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CWO2 (N-2) | 11 | Δn | 0.111 |
| 2CLWO2 (II-3) | 8 | Cp | 85 |
| 3CLWO2 (II-3) | 8 | Δε | −3.6 |
| 4CLWO2 (II-3) | 8 | K₁₁ | 16.3 |
| 5CLWO2 (II-3) | 8 | K₃₃ | 18.6 |
| 3CCV (M-1) | 21 | γ₁ | 81 |
| 3CCV1 (M-1) | 12 | τ | 26.5 |
| 1PP2V (M-4) | 8 | Tr | 15.6 |
| 3PWWO2 (III-7) | 2 | CR | 1628 |
| 4PWWO2 (III-7) | 2 | LTS(−40° C.) | 168 |
| 2OB(S)O1C(5, V) (I-1) | 6 | | |
| 4OB(S)O1C(5, V) (I-1) | 6 | | |

### Example 7

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CWO2 (N-2) | 19 | Δn | 0.115 |
| 3CLWO2 (II-3) | 8 | Cp | 70 |
| 4CLWO2 (II-3) | 8 | Δε | −3.5 |
| 5CLWO2 (II-3) | 4 | K₁₁ | 15 |
| 3CCV (M-1) | 21 | K₃₃ | 16.8 |
| 3CCV1 (M-1) | 12 | γ₁ | 65 |
| 1PP2V (M-4) | 8 | τ | 21.3 |
| 3PWP2 (III-6) | 3 | Tr | 15.7 |
| 4PWP2 (III-6) | 2 | CR | 1430 |
| 3G′G′WO2 (III-3) | 3 | LTS(−40° C.) | 168 |
| 4G′G′WO2 (III-3) | 2 | | |
| 2OB(S)O1C(5, V) (I-1) | 5 | | |
| 4OB(S)O1C(5, V) (I-1) | 5 | | |

### Example 8

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3C1OWO2 (N-5) | 5 | Δn | 0.12 |
| 3PWO2 (N-14) | 5 | Cp | 82 |
| 3OPWO2 (N-14) | 5 | Δε | −3.9 |
| 3CLWO2 (II-3) | 6 | K₁₁ | 16.1 |
| 4CLWO2 (II-3) | 6 | K₃₃ | 17.9 |
| 5CLWO2 (II-3) | 6 | γ₁ | 79 |
| 3CCV (M-1) | 29 | τ | 24.5 |
| 3CCV1 (M-1) | 12 | Tr | 15.7 |
| 1PGP2V (M-15) | 2 | CR | 1383 |
| 2GGWO2 (III-5) | 4 | LTS(−40° C.) | 120 |
| 3GGWO2 (III-5) | 4 | | |
| 4GGWO2 (III-5) | 4 | | |
| 2OB(O)O1C(5, V) (I-1) | 6 | | |
| 3OB(O)O1C(5, V) (I-1) | 6 | | |

### Example 9

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CWO2 (N-2) | 5 | Δn | 0.112 |
| 3LWO2 (II-1) | 5 | Cp | 83 |
| 3OG′WO2 (N-27) | 6 | Δε | −3.9 |
| 3CLWO2 (II-3) | 4 | K₁₁ | 15.1 |
| 4CLWO2 (II-3) | 4 | K₃₃ | 17.7 |
| 5CLWO2 (II-3) | 4 | γ₁ | 77 |
| 3CC1OWO2 (N-10) | 6 | τ | 24.3 |
| 4CC1OWO2 (N-10) | 6 | Tr | 15.5 |
| 3CCV (M-1) | 26 | CR | 1390 |
| 5CCV1 (M-1) | 8 | LTS(−40° C.) | 168 |
| 1PP2V1 (M-4) | 4 | | |
| 3CPP2V1 (M-13) | 4 | | |
| 3PWPO2 (III-6) | 2 | | |
| 4PWPO2 (III-6) | 2 | | |
| 5PWPO2 (III-6) | 2 | | |
| 1OB(S)O1C(5, V) (I-1) | 6 | | |
| 2OB(S)O1C(5, V) (I-1) | 6 | | |

### Example 10

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CWO2 (N-2) | 17 | Δn | 0.118 |
| 3CLWO2 (II-3) | 8 | Cp | 84 |
| 4CLWO2 (II-3) | 8 | Δε | −3.3 |
| 5CLWO2 (II-3) | 8 | K₁₁ | 15.2 |
| 3CCV (M-1) | 25 | K₃₃ | 16.9 |
| 3CCV1 (M-1) | 4 | γ₁ | 78 |
| V2CCP1 (M-11) | 4 | τ | 24.2 |
| 3CPP2V (M-13) | 2 | Tr | 15.2 |
| 3CPP2V1 (M-13) | 2 | CR | 1348 |
| 1PP2V (M-4) | 4 | LTS(−40° C.) | 216 |
| 3PPWO2 (III-1) | 3 | | |
| 3PGWO2 (III-4) | 3 | | |
| 3PG′WO2 (III-2) | 3 | | |
| 3PWP2 (III-6) | 3 | | |
| 2OB(S)O1C(5, V) (I-1) | 3 | | |
| 4OB(S)O1C(5, V) (I-1) | 3 | | |

### Example 11

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3CPO2 (M-2) | 5 | Δn | 0.121 |
| 3PPO2 (M-3) | 5 | Cp | 78 |
| 3LCWO2 (II-2) | 9 | Δε | −3.4 |
| 4LCWO2 (II-2) | 9 | K₁₁ | 16.6 |
| 5LCWO2 (II-2) | 8 | K₃₃ | 19.1 |
| 3CCV (M-1) | 33 | γ₁ | 78 |
| 1PP2V (M-4) | 7 | τ | 23.9 |
| V2PWPO2 (III-6) | 2 | Tr | 16.9 |
| 1V2PWPO2 (III-6) | 2 | CR | 1476 |
| V2PGWO2 (III-4) | 2 | LTS(−40° C.) | 240 |
| 1V2PGWO2 (III-4) | 2 | | |
| 2OB(S)OV(2F) (B-1-4) | 4 | | |
| 4OB(S)OV(2F) (B-1-4) | 4 | | |
| 2OB(S)O1C(5, V) (I-1) | 4 | | |
| 4OB(S)O1C(5, V) (I-1) | 4 | | |

### Example 12

The present Example provides a liquid crystal composition comprising components in the percentages by weight as shown in the table below, and the performance tests are carried out by filling the same into the two substrates of the liquid crystal display device:

| | | Test result of performance | |
|---|---|---|---|
| Code of component | Content | parameters | |
| 3LWO2 (II-1) | 10 | Δn | 0.106 |
| 3OPWO2 (N-14) | 6 | Cp | 86 |
| 3CLWO2 (II-3) | 7 | Δε | −3.8 |
| 3LCWO2 (II-2) | 7 | K₁₁ | 15 |
| 3CC1OWO2 (N-10) | 10 | K₃₃ | 17.3 |
| 3CCV (M-1) | 26 | γ₁ | 80 |
| 3CCV1 (M-1) | 8 | τ | 24.5 |
| 1PP2V1 (M-4) | 4 | Tr | 15.4 |
| 3CCECC3 (M-28) | 4 | CR | 1428 |
| 3PG′WO2 (III-2) | 2 | LTS(−40° C.) | 192 |
| 4PG′WO2 (III-2) | 2 | | |
| 5PG′WO2 (III-2) | 2 | | |
| 1OB(S)O1C(5, V) (I-1) | 6 | | |
| 2OB(S)O4O1 (B-1-2) | 3 | | |
| 2OB(O)O1THF (B-4) | 3 | | |

In conclusion, the liquid crystal composition provided by the present invention has a better optical anisotropy, a better clearing point, an appropriate absolute value of dielectric anisotropy, a larger K value (K₁₁, K₃₃), a smaller rotational viscosity, a shorter response time, a higher transmittance, a higher contrast rate and a longer low-temperature storage time, which makes the liquid crystal display device containing the liquid crystal composition of the present invention have a wider using temperature range, a lower threshold voltage, a better contrast rate, a faster response speed, a faster refresh speed and a higher transmittance and suitable for VA, IPS, NFFS display modes and the like.

The applicant declares that the liquid crystal composition and liquid crystal display device of the present invention is illustrated by the above Examples, but the present invention is not limited to the above Examples, that is, it does not mean that the implement of the present application must rely on the above Examples. It shall be clear to the person skilled in the art that any improvements of the present invention, equivalent replacements of the raw materials used in the present invention, the additions of any auxiliary components, the selection of specific methods or the like all fall into the protection scope and the disclosure scope of the present invention.

### INDUSTRIAL APPLICABILITY

The liquid crystal composition involved in the present invention can be applied to the liquid crystal field.

1-10. (canceled)

11. A liquid crystal composition comprising at least one compound of general formula I-1, at least two compounds of general formula II and at least two compounds of general formula III: 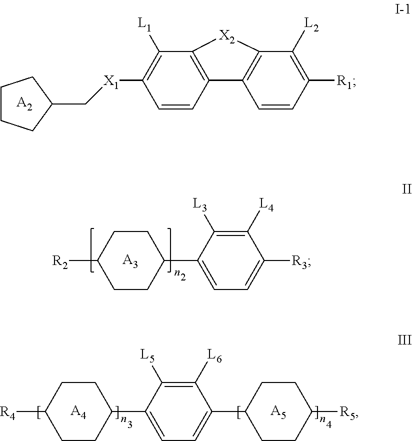
wherein, R₁ represents —H, C₁₋₁₂ halogenated or unhalogenated linear alkyl, C₃₋₁₂ halogenated or unhalogenated branched alkyl, C₁₋₁₂ halogenated or unhalogenated alkoxy, C₂₋₁₂ halogenated or unhalogenated alkenyl, C₂₋₁₂ halogenated or unhalogenated alkenoxy, 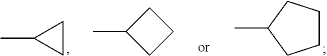
R₂˜R₅ each independently represents C₁₋₁₂ linear alkyl, C₃₋₁₂ branched alkyl, C₁₋₁₂ alkoxy, C₂₋₁₂ alkenyl, C₂₋₁₂ alkenoxy, 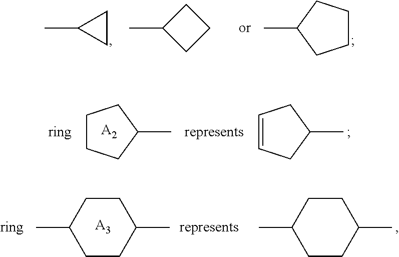
one or at least two —CH₂— in 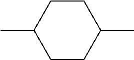
can be replaced by —O—, one or at least two single bond in the rings can be replaced by double bond, and one or at least two single bond in at least one ring 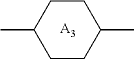
is replaced by double bond;
ring 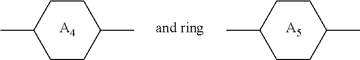
each independently represents 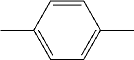
one or at least two —H on 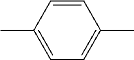
can each be independently replaced by —F, —Cl, —CN, —CH₃ or —OCH₃, one or at least two —CH═ in the rings can be replaced by —N═;
L₁-L₆ each independently represents halogen atom;
X₁ and X₂ each independently represents —O— or —S—;
n₂ represents 1 or 2, when n₂ represents 2, ring 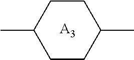
is the same or different; and
n₃ represents 0, 1, 2 or 3, n₄ represents 0 or 1, and 2≤n₃+n₄≤3; when n₃ represents 2 or 3, ring 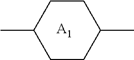
is the same or different;
in the liquid crystal composition, percentage by weight of the compound of general formula I-1 is 0.1%-30%;
in the liquid crystal composition, percentage by weight of the compound of general formula II is 0.1%-50%;
in the liquid crystal composition, percentage by weight of the compound of general formula III is 0.1%-30%;
the liquid crystal composition further comprises at least one compound of general formula N: 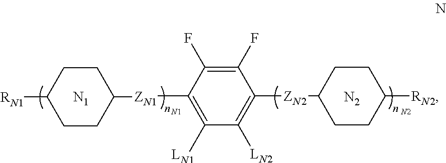
wherein, RN1 and RN2 each independently represents C1-12 linear alkyl, C3-12 branched alkyl, 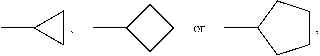
wherein one or at least two nonadjacent —CH₂— in the C1-12 linear alkyl and C3-12 branched alkyl can each be independently replaced by —CH═CH—, —C≡C—, —O—, —CO—, —CO—O— or —O—CO—;
ring 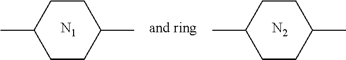
each independently represents 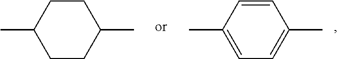
wherein one or at least two —CH₂— in 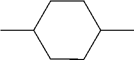
can be replaced by —O—; one or at least two —H on 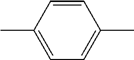
can each be independently replaced by —F, —Cl or —CN, one or at least two —CH═ in the rings can be replaced by —N═;
Z_{N1} and Z_{N2} each independently represents single bond, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
L_{N1} and L_{N2} each independently represents —H, C₁₋₃ alkyl, or halogen atom;
n_{N1} represents 0, 1, 2 or 3, n_{N2} represents 0 or 1, and 0≤n_{N1}+n_{N2}≤3, wherein when n_{N1} represents 2 or 3, ring 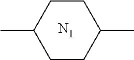
is the same or different, and Z_{N1} is the same or different; and
substituted or unsubstituted terphenyl structure is not contained in the compound of general formula N, the substituent for substitution is selected from —F, —Cl or —CN;
in the liquid crystal composition, percentage by weight of the compound of general formula N is 0.1%-30%;
the liquid crystal composition further comprises at least one compound of general formula M: 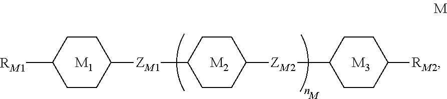
wherein, R_{M1} and R_{M2} each independently represents C₁₋₁₂ linear alkyl, C₃₋₁₂ branched alkyl, 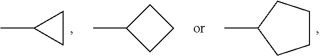
wherein one or at least two nonadjacent —CH₂— in the C1-12 linear alkyl and C3-12 branched alkyl can each be independently replaced by —CH═CH—, —C≡C—, —O—, —CO—, —CO—O— or —O—CO—;
ring 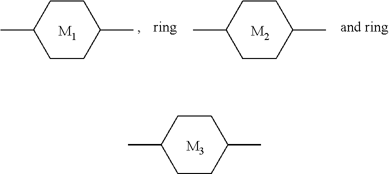
each independently represents 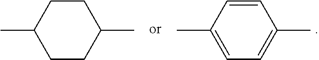
wherein one or at least two —CH₂— in 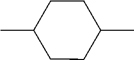
can be replaced by —O—, one or at least two single bond in the rings can be replaced by double bond; at most one —H on 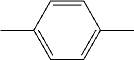
can be replaced by halogen atom;
ZM1 and ZM2 each independently represents single bond, —CO—O—, —O—CO—, —CH₂O—, —OCH₂—, —C≡C—, —CH—CH—, —CH₂CH₂— or —(CH₂)₄—;
n_{M} represents 0, 1 or 2, wherein when ny represents 2, ring 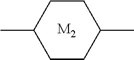
is the same or different, Z_{M2} is the same or different;
in the liquid crystal composition, percentage by weight of the compound of general formula Mis 0.1%-60%.

12. The liquid crystal composition according to claim 11, wherein L₁ and L₂ represent fluorine atom.

13. The liquid crystal composition according to claim 11, wherein the liquid crystal composition comprises at least two compounds of general formula I-1.

14. The liquid crystal composition according to claim 11, wherein, in the liquid crystal composition, percentage by weight of the compound of general formula I-1 is 1%-20%.

15. The liquid crystal composition according to claim 14, wherein, in the liquid crystal composition, percentage by weight of the compound of general formula I-1 is 4%-16%.

16. The liquid crystal composition according to claim 11, wherein the compound of general formula II is any one or the combination of at least two of the compounds with the following structures: 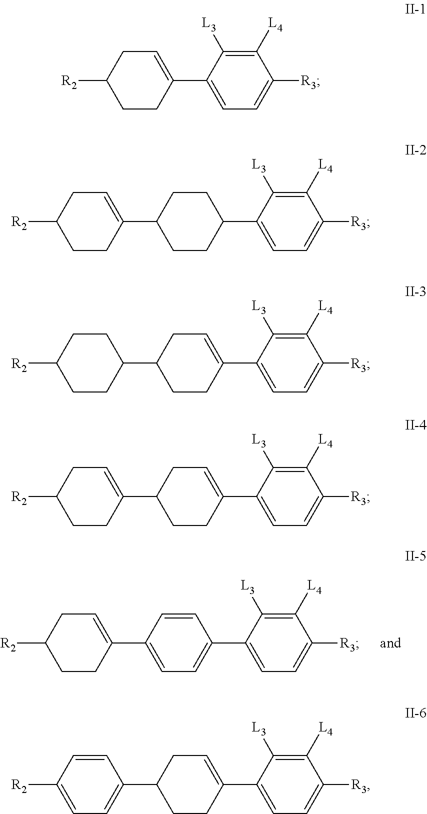
wherein, R₂, R₃, L₃, and L₄ have the same protection scopes as those in claim 11.

17. The liquid crystal composition according to claim 11, wherein L₃ and L₄ both represent fluorine atom.

18. The liquid crystal composition according to claim 11, wherein, in the liquid crystal composition, percentage by weight of the compound of general formula II is 15%-36%.

19. The liquid crystal composition according to claim 11, wherein the compound of general formula III is any one or the combination of at least two of the compounds with the following structures: 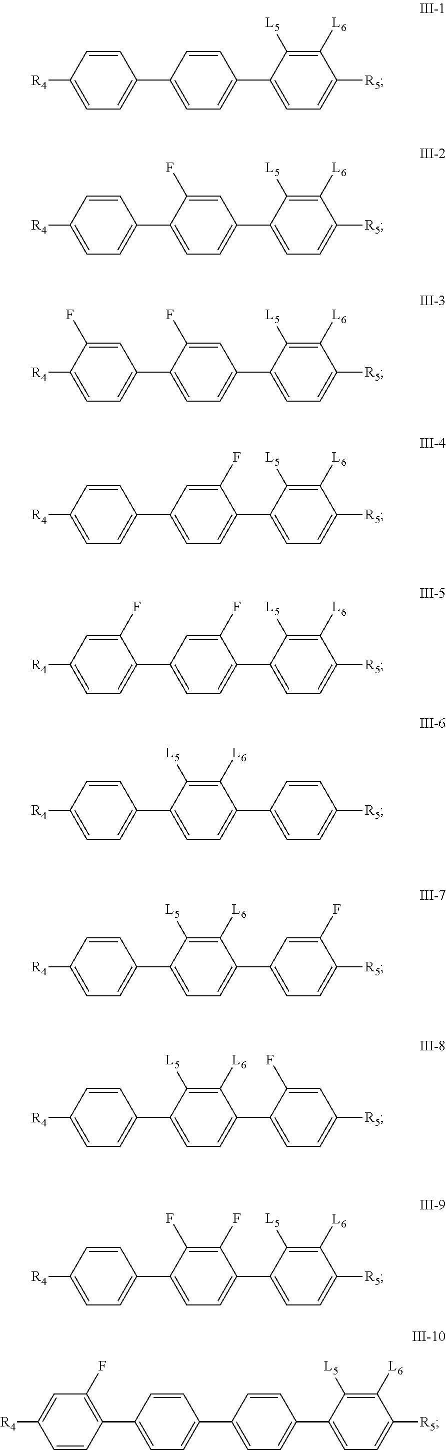 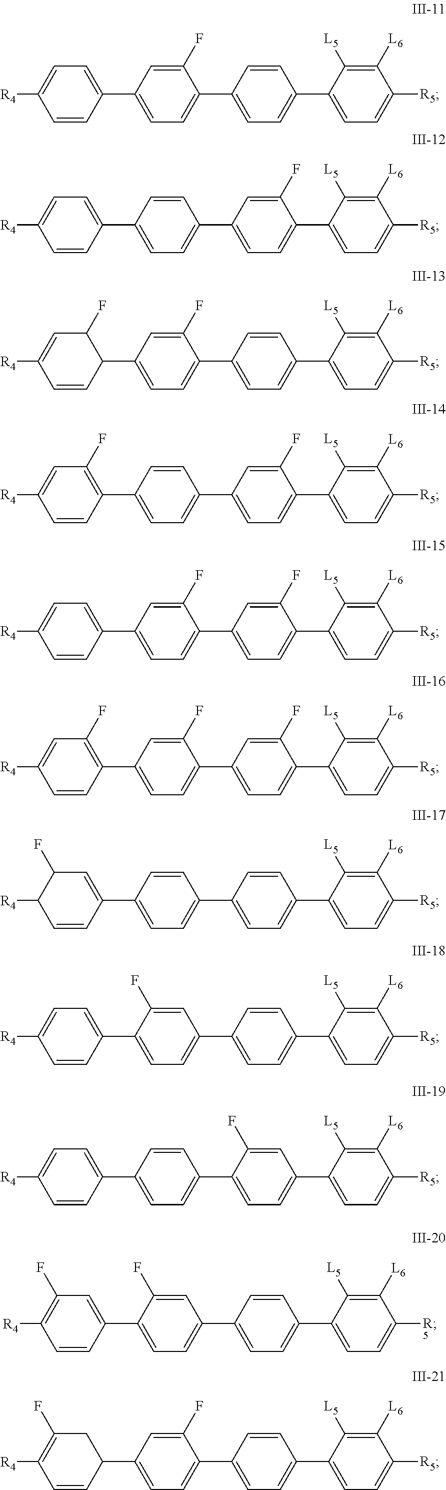 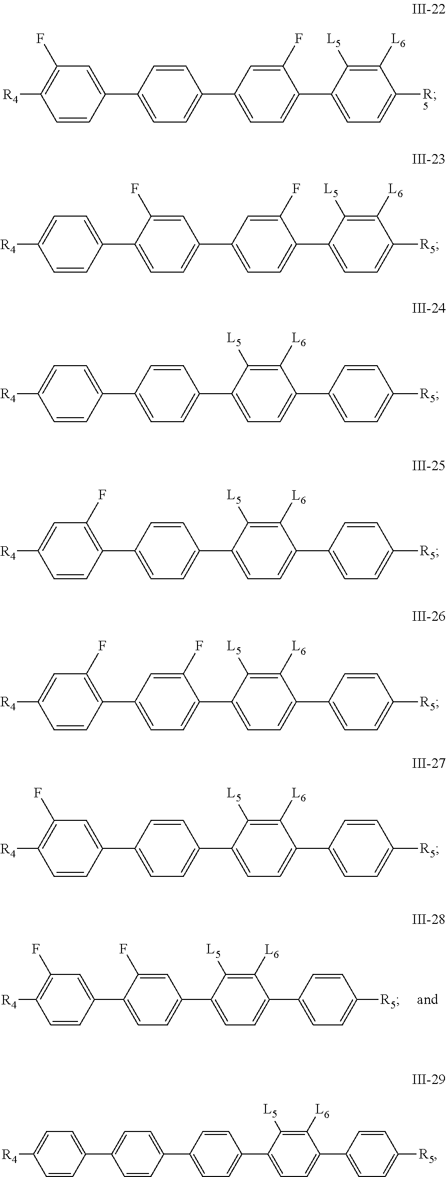
wherein, R₄, R₅, L₅, and L₆ have the same protection scopes as those in claim 11.

20. The liquid crystal composition according to claim 11, wherein L₅ and L₆ both represent fluorine atom.

21. The liquid crystal composition according to claim 11, wherein, in the liquid crystal composition, percentage by weight of the compound of general formula III is 3%-15%.

22. The liquid crystal composition according to claim 11, wherein the compound of general formula N is any one or the combination of at least two of the compounds with the following structures: 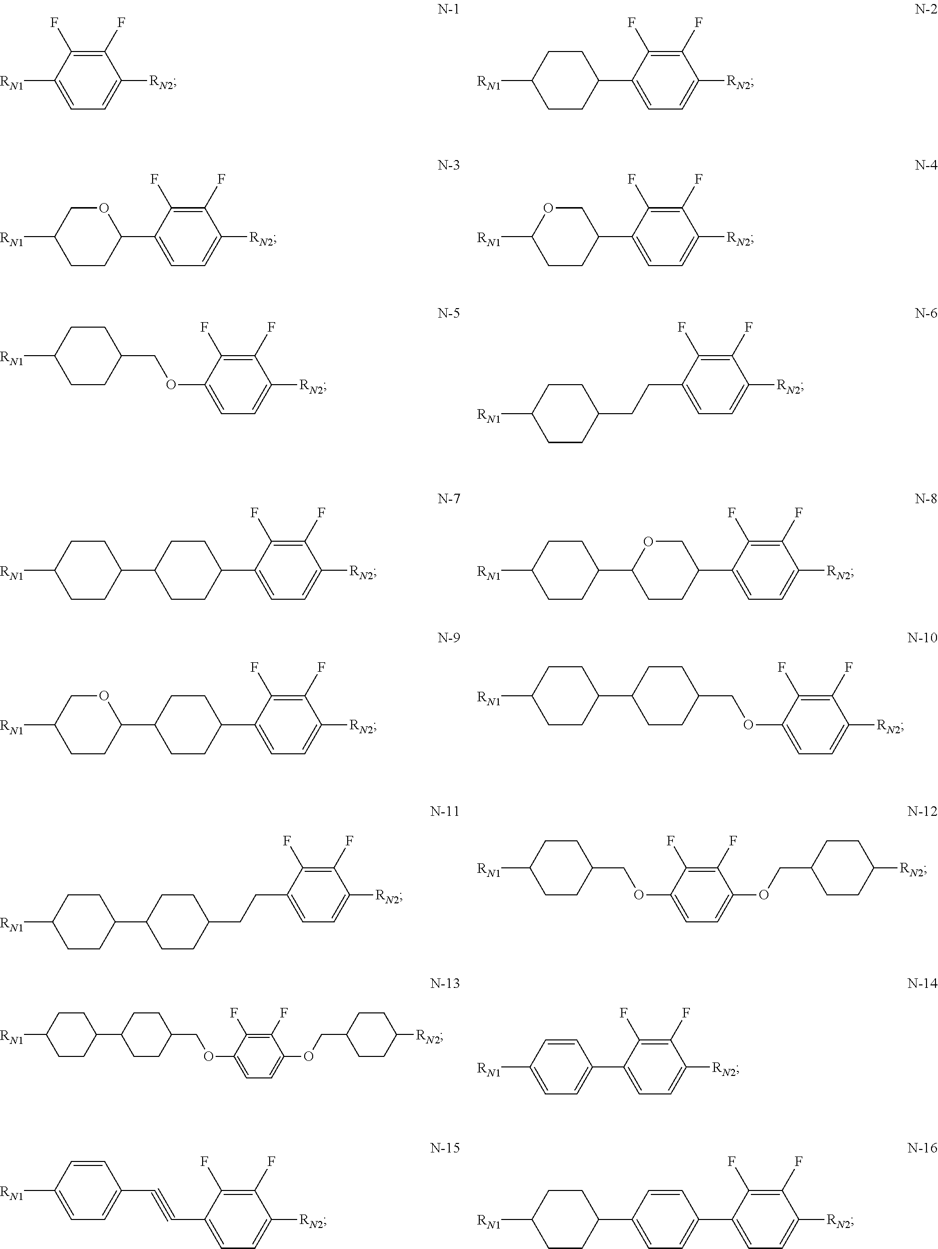 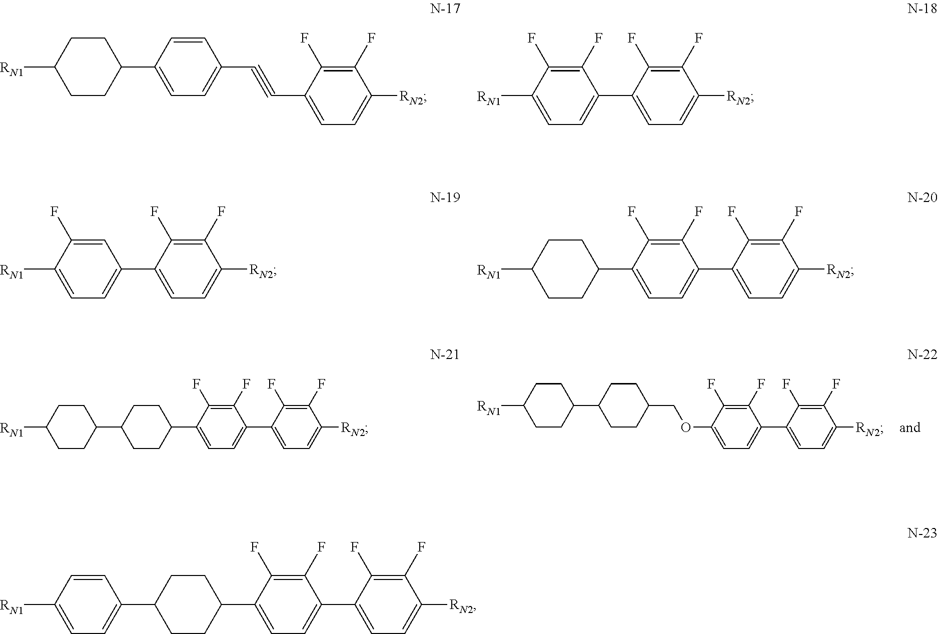
wherein, R_{N1} and R_{N2} have the same protection scopes as those in claim 11.

23. The liquid crystal composition according to claim 22, wherein the compound of general formula N is any one or the combination of at least two of the compounds with the following structures:

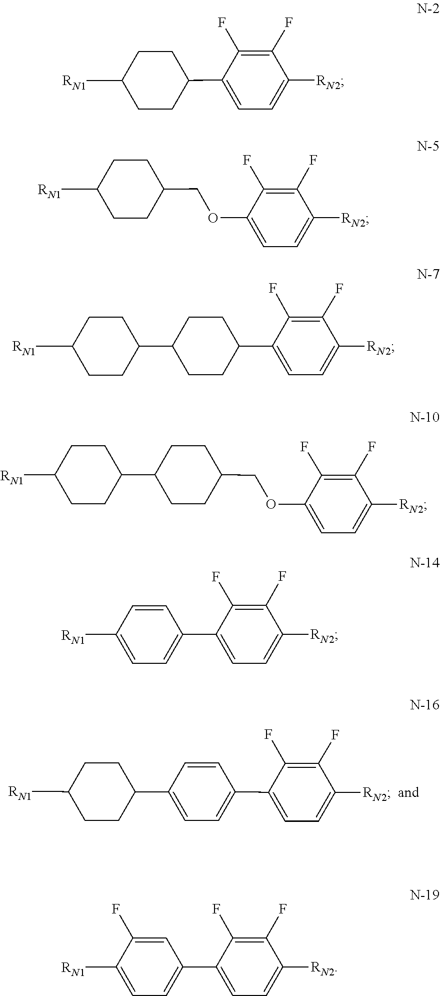

24. The liquid crystal composition according to claim 11, wherein, in the liquid crystal composition, percentage by weight of the compound of general formula N is 5%-25%.

25. The liquid crystal composition according to claim 11, wherein the compound of general formula M is any one or the combination of at least two of the compounds with the following structures: 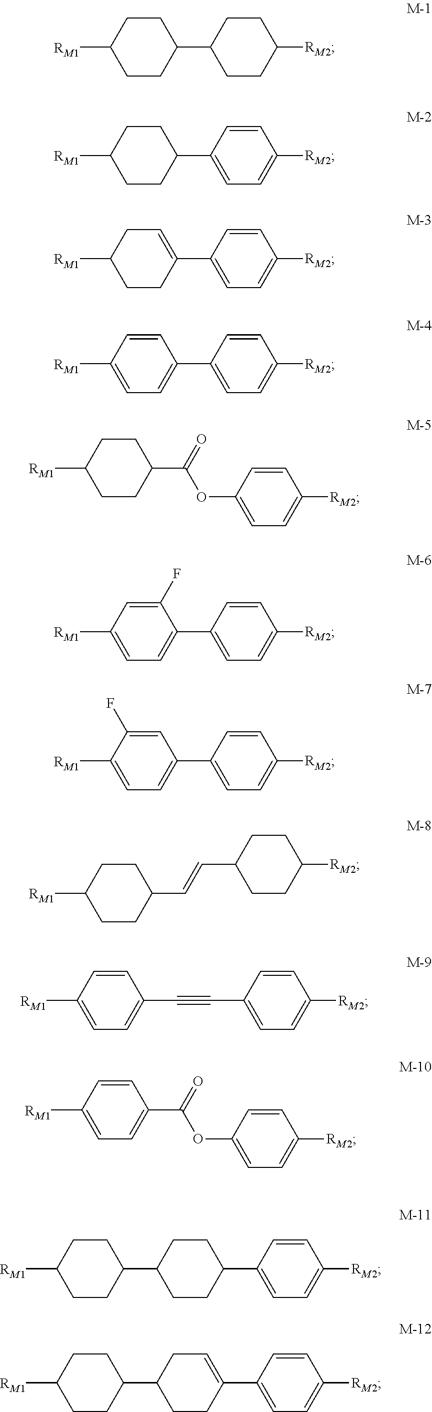 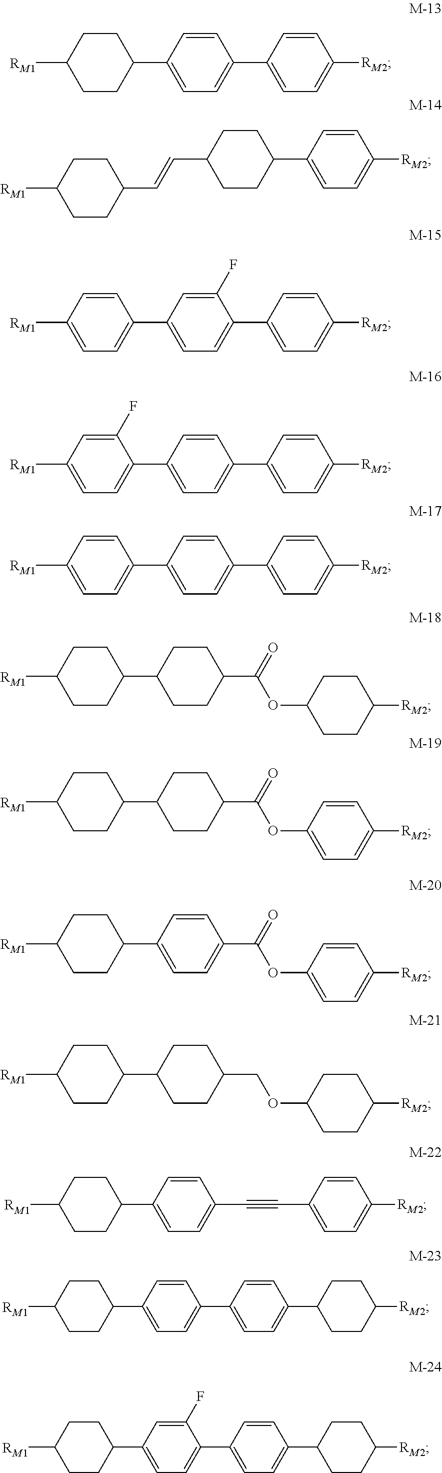 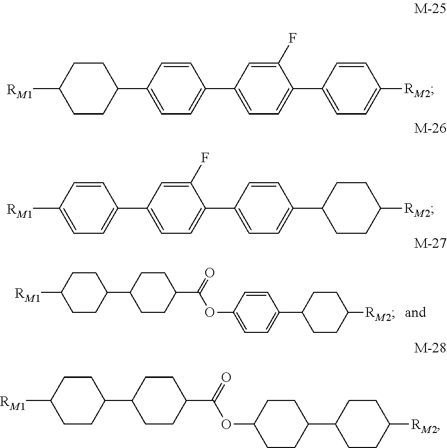
wherein, R_{M1} and R_{M2} have the same protection scopes as those in claim 11.

26. The liquid crystal composition according to claim 25, wherein the compound of general formula M is any one or the combination of at least two of the compounds with the following structures:

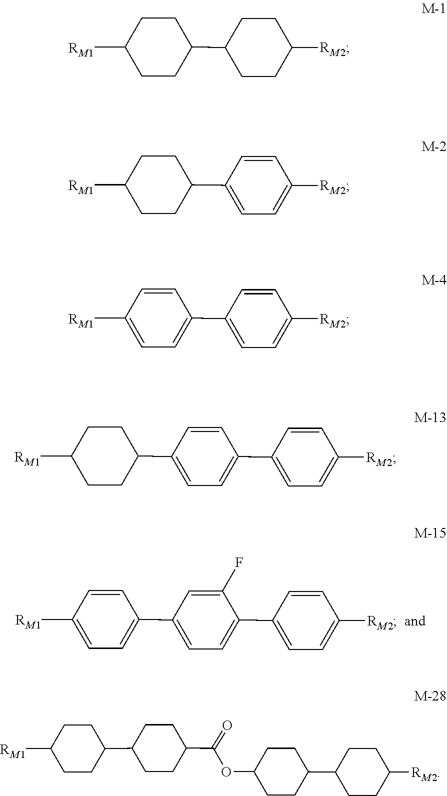

27. The liquid crystal composition according to claim 11, wherein, in the liquid crystal composition, percentage by weight of the compound of general formula M is 30%-50%.

28. The liquid crystal composition according to claim 11, wherein the liquid crystal composition further comprises at least one compound of general formula B: 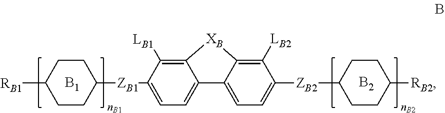
wherein, R_{B1} and R_{B2} each independently represents halogen atom, C₁₋₁₂ halogenated or unhalogenated linear alkyl, C₃₋₁₂ halogenated or unhalogenated branched alkyl, 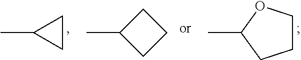
wherein one or at least two nonadjacent —CH₂— in the C₁₋₁₂ halogenated or unhalogenated linear alkyl, C₃₋₁₂ halogenated or unhalogenated branched alkyl, 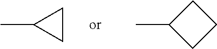
can each independently be replaced by —CH═CH—, —C≡C-, —CH═CF—, —O—, —CO—, —CO—O— or —O—CO—;
ring 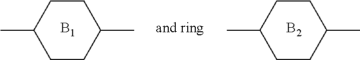
each independently represents 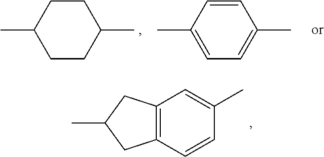
wherein one or at least two nonadjacent —CH₂— in 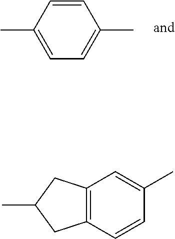
can be replaced by —O—, one or at least two single bond in the rings can be replaced by double bond; one or at least two —H on 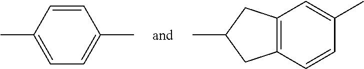
can each be independently replaced by —CN, —F or —Cl, one or at least two —CH═ in the rings can be replaced by —N═;
X_{B} represents —O—, —S— or —CO—;
L_{B1} and L_{B2} each independently represents —H, —F, —Cl, —CF₃ or —OCF₃;
Z_{B1} and Z_{B2} each independently represents single bond, —CO—O—, —O—CO—, —CH₂O—, —OCH₂—, —CH═CH—, —C≡C—, —CH₂CH₂—, —CF₂CF₂—, —(CH₂)n_{B4}—, —(CH₂)n_{B4}O—, —(CH₂)n_{B4}S—, —CF₂O— or —OCF₂—, wherein n_{B4} represents an integer of 0-5;
n_{B1} and n_{B2} each independently represents 0, 1 or 2, wherein when nBi represents 2, ring 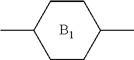
is the same or different, when n_{B2} represents 2, ring 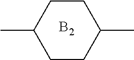
is the same or different, Z_{B2} is the same or different.

29. The liquid crystal composition according to claim 28, wherein the compound of general formula B is any one or the combination of at least two of the compounds with the following structures: 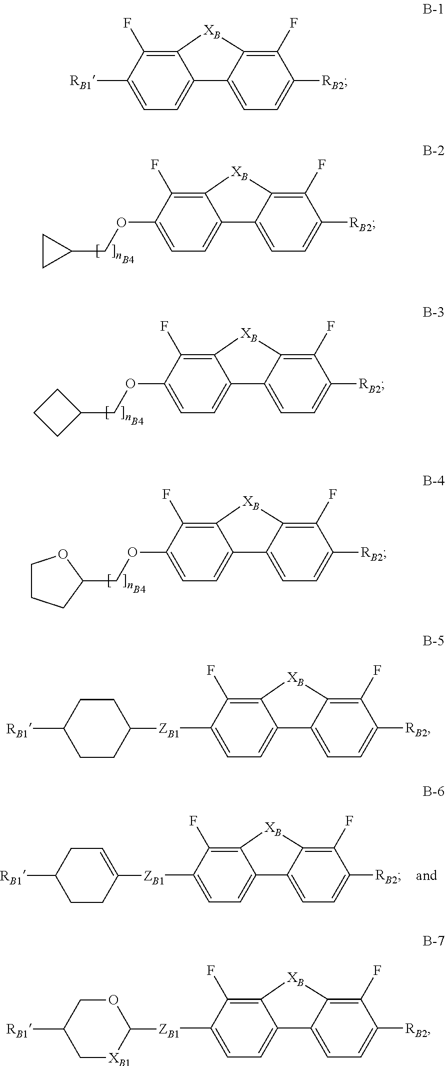
wherein, R_{B1}′ represents C₁₋₈ alkyl, C₁₋₈ alkoxy, C₂₋₈ alkenyl;
XB1 represents —O— or —CH₂—;
R_{B2}, X_{B} and Z_{B1} have the same protection scopes as those in claim 28.

30. The liquid crystal composition according to claim 29, wherein the compound of general formula B-1 is any one or the combination of at least two of the compounds with the following structures: 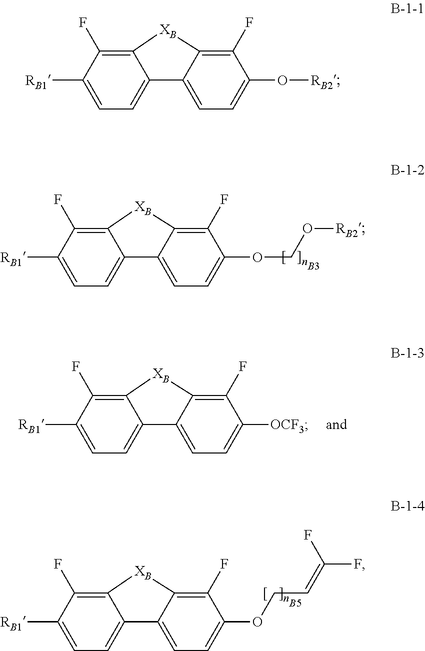
wherein, R_{B2}′ represents C₁₋₈ alkyl;
R_{B1}′ represents C₁₋₈ alkyl, C₁₋₈ alkoxy or C₂₋₈ alkenyl,
X_{B1} represents —O— or —CH₂—;
n_{B4} represents an integer of 0-5;
n_{B3} represents 1, 2, 3 or 4;
n_{B5} represents 0, 1, 2, 3 or 4.

31. The liquid crystal composition according to claim 28, wherein, in the liquid crystal composition, percentage by weight of the compound of general formula B is 0.1%-20%.

32. The liquid crystal composition according to claim 31, wherein, in the liquid crystal composition, percentage by weight of the compound of general formula B is 1%-10%.

33. A liquid crystal display device, wherein the liquid crystal display device comprises the liquid crystal composition of claim 11.
